(19) United States
(12) Patent Application Publication
(10) Pub. No.: US 2018/0343162 A1
(43) Pub. Date: Nov. 29, 2018

(54) SYSTEM MANAGEMENT APPARATUS AND SYSTEM MANAGEMENT METHOD

(71) Applicant: FUJITSU LIMITED, Kawasaki-shi (JP)

(72) Inventors: Kadohito Ohsuga, Numazu (JP); Yoshiyuki Kawano, Kawasaki (JP); Kazuhiro Miyashita, Yokohama (JP)

(73) Assignee: FUJITSU LIMITED, Kawasaki-shi (JP)

(21) Appl. No.: 15/987,219

(22) Filed: May 23, 2018

(30) Foreign Application Priority Data
May 26, 2017 (JP) 2017-105020

(51) Int. Cl. H04L 12/24; H04L 12/707; H04L 12/26

(52) U.S. Cl. CPC H04L 41/0668; H04L 43/0811; H04L 45/22

(57) ABSTRACT

A system management apparatus for managing a network system, the system management apparatus includes a processor configured to perform specifying of a first communication path including the L3 relay apparatus between a first pair of information processing apparatuses included in the network system and a second communication path not including any L3 relay apparatus between a second pair of information processing apparatuses included in the network system, store management information in the memory, the management information including information of the first communication path and the second communication path in association with information of the first pair of information processing apparatuses and the second pair of information processing apparatuses, and when a failure occurs in the network system, perform a detection of communication between a third pair of information processing apparatuses affected by the failure.

### CROSS-REFERENCE TO RELATED APPLICATION

This application is based upon and claims the benefit of priority of the prior Japanese Patent Application No. 2017-105020, filed on May 26, 2017, the entire contents of which are incorporated herein by reference.

### FIELD

The embodiments discussed herein are related to a system management technique.

### BACKGROUND

A cloud system has a complicated configuration constructed by many servers, switches, and others to realize provision of services to multiple customers. When a failure occurs in such a complicated environment, to support a cloud provider, a cloud management apparatus that manages the cloud system specifies customers affected by the failure based on physical path information and configuration information of a virtual system stored in advance.

Note that there is a technique for associating network identifiers for routing with computer identifiers by: grouping multiple computers to execute a program to be executed in parallel, for each relay apparatus in the bottom layer among relay apparatuses of a hierarchical configuration; sorting the groups thus formed; and allocating the identifiers to the computers in the order of the sorting.

There is also a technique for generating a VLAN setting information table in such a way that redundant paths for paths that connect switches A and B connected to terminals that configure a VLAN are specified based on information on physical connection states of network connection devices and connection states thereof in a spanning tree.

The related arts are disclosed in, for example, Japanese Laid-open Patent Publication Nos. 2012-98881 and 2007-158764.

### SUMMARY

According to an aspect of the invention, a system management apparatus for managing a network system, the system management apparatus includes a processor configured to perform specifying of a first communication path including a L3 relay apparatus between a first pair of information processing apparatuses included in the network system and a second communication path not including any L3 relay apparatus between a second pair of information processing apparatuses included in the network system, store management information in the memory, the management information including information of the first communication path and the second communication path in association with information of the first pair of information processing apparatuses and the second pair of information processing apparatuses, and when a failure occurs in the network system, perform a detection of communication between a third pair of information processing apparatuses affected by the failure.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an information processing system according to a first embodiment;

FIG. 2 is a diagram illustrating a functional configuration of a cloud management apparatus;

FIG. 3 is a diagram illustrating an example of a redundancy management table;

FIG. 4 is a diagram illustrating an example of a connection link management table;

FIG. 5 is a diagram illustrating an example of a VM management table;

FIG. 6 is a diagram illustrating an example of a server management table;

FIG. 7 is a diagram illustrating an example of a server group management table;

FIG. 8 is a diagram illustrating an example of a target system used for creation of FIGS. 6 and 7;

FIG. 9A is a diagram illustrating an example 1 of group allocation;

FIG. 9B is a diagram illustrating an example 2 of the group allocation;

FIG. 10 is a diagram illustrating an example of a physical path table;

FIG. 11 is a diagram illustrating an example of specifying an influence range considering redundant paths;

FIG. 12A is a first diagram illustrating an example of specifying an influence range when a failure occurs in a path between a server and an edge switch;

FIG. 12B is a second diagram illustrating an example of specifying an influence range when a failure occurs in the path between the server and the edge switch;

FIG. 13 is a flowchart illustrating a flow of processing of creating a server group;

FIG. 14 is a flowchart illustrating a flow of processing of creating a physical path table;

FIG. 15A is a first flowchart illustrating a flow of processing of specifying an influence range;

FIG. 15B is a second flowchart illustrating the flow of the processing of specifying an influence range;

FIG. 16 is a diagram illustrating an information processing system used for explanation of an example of specifying an influence range;

FIG. 17 is a diagram illustrating a redundancy management table, a connection link management table, and a VM management table corresponding to the information processing system illustrated in FIG. 16;

FIG. 18 is a diagram illustrating states of the server management table and the server group management table at the time when a server group subordinate to a switch #1 is registered;

FIG. 19 is a diagram illustrating states of the server management table and the server group management table at the time when server groups subordinate to switches #2 to #4 are registered;

FIG. 20 is a diagram illustrating a state of the physical path table at the time when a path #1 is registered;

FIG. 21 is a diagram illustrating a state of the physical path table at the time when paths #2 to #4 are registered;

FIG. 22 is a diagram illustrating a state of the physical path table at the time when overlapping paths are deleted;

FIG. 23 is a diagram illustrating a state at the time when a failure occurs between switches;

FIG. 24 is a diagram illustrating a state at the time when a failure occurs between the server and the switch;

FIG. 25 is a diagram for explaining an effect obtained when servers are grouped;

FIG. 26 is a diagram illustrating a hardware configuration of a computer that executes an influence range specifying program according to the first embodiment;

FIG. 27 is a diagram illustrating an information processing system including an L3 relay apparatus and a physical path table;

FIG. 28A is a diagram for explaining collection of configuration information of an information processing system outside a data center;

FIG. 28B is a diagram illustrating desirable configuration information on a client environment illustrated in FIG. 28A;

FIG. 29 is a diagram illustrating an example of a physical path table to be imported;

FIG. 30 is a diagram illustrating a functional configuration of the cloud management apparatus;

FIG. 31 is a diagram illustrating an example of a physical path table;

FIG. 32 is a diagram illustrating an example of an apparatus management table;

FIG. 33 is a flowchart illustrating a flow of processing until creation of the physical path table;

FIG. 34 is a flowchart illustrating a flow of processing of specifying an influence range during failure occurrence;

FIG. 35A is a first flowchart illustrating a flow of processing of creating the physical path table;

FIG. 35B is a second flowchart illustrating the flow of the processing of creating the physical path table;

FIG. 36 is a third flowchart illustrating the flow of the processing of specifying an influence range;

FIG. 37 is a diagram illustrating the configuration of a target system for which the influence range is specified;

FIG. 38 is a diagram illustrating a physical path table created for the target system illustrated in FIG. 37; and

FIG. 39 is a diagram illustrating inter-server group communications affected by a failure.

### DESCRIPTION OF EMBODIMENTS

When a layer 3 (L3) relay apparatus that treats packets in the layer 3 or higher is present in a cloud system, turning back sometimes occurs in the L3 relay apparatus. In related art, information on a physical path turning back at the L3 relay apparatus is not included in physical path information used in processing of specifying customers affected when a failure occurs. Therefore, the affected customers may not be accurately specified.

System management apparatuses, system management methods, and computer programs according to embodiments are explained in detail below with reference to the drawings. In a first embodiment, an information processing system is explained that reduces an amount of physical path information used for specifying customers affected by a failure to reduce a time taken for the processing of specifying the affected customers. In a second embodiment, an information processing system is explained that specifies a physical path affected by a failure including a physical path turning back in the L3 relay apparatus. Note that the embodiments do not limit the disclosed technique.

### First Embodiment

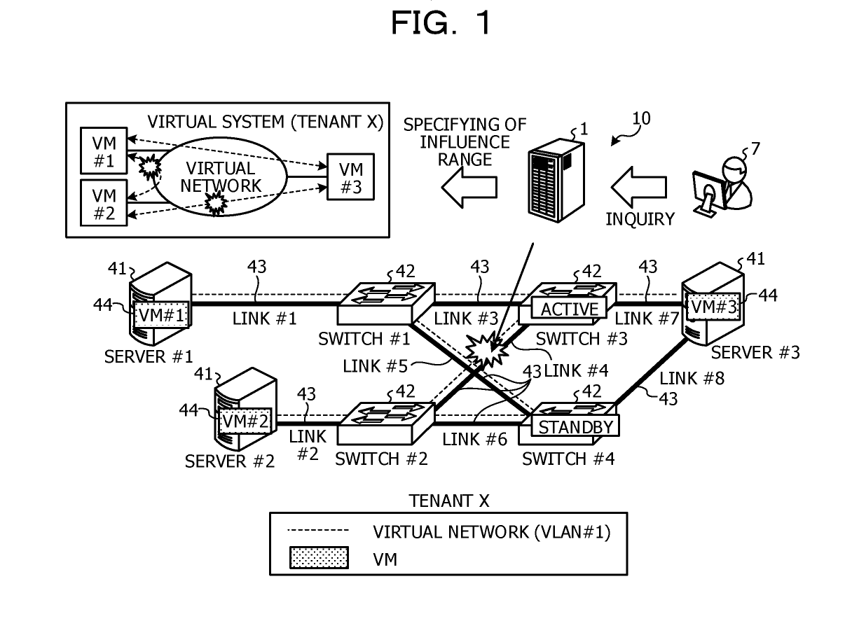

First, an information processing system according to a first embodiment is explained. FIG. 1 is a diagram for explaining the information processing system according to the first embodiment. As illustrated in FIG. 1, an information processing system 10 according to the first embodiment includes a cloud management apparatus 1, three servers 41, and four switches 42. The three servers 41 are represented by servers #1 to #3. The four switches 42 are represented by switches #1 to #4. The switch #4 is a standby switch 42. The switches #3 and #4 are in a node redundant relation. The servers 41 and the switches 42 are connected by links 43. The switches 42 are connected by links 43. In FIG. 1, eight links 43 are represented by links #1 to #8. The links 43 are represented by solid lines. For example, the server #1 and the switch #1 are connected by the link #1.

The servers 41 are information processing apparatuses that perform information processing. The switches 42 are apparatuses that relay communication among the servers 41. Note that, in FIG. 1, the information processing system 10 includes the three servers 41, the four switches 42, and the eight links 43. However, the information processing system 10 may include any numbers of the servers 41, the switches 42, and the links 43.

A VM #1 operates in the server #1, a VM #2 operates in the server #2, and a VM #3 operates in the server #3. The VM indicates a virtual machine that operates on the server 41. VMs are allocated to tenants that use the information processing system 10. Virtual networks are allocated to the tenants that use the information processing system 10. In FIG. 1, a virtual local area network (VLAN) #1 is allocated to a tenant X. The virtual networks are represented by broken lines. Note that, in FIG. 1, one VM 44 is allocated to one server 41. One virtual network is allocated to one tenant. However, multiple VMs 44 may be allocated to one server 41. Multiple virtual networks may be allocated to one tenant.

The cloud management apparatus 1 is an apparatus that, when a failure occurs in a network, specifies affected customers by specifying affected inter-VM communication. For example, when a failure occurs in a network infrastructure, a cloud provider 7, which operates a cloud system, inquires about an influence range to the cloud management apparatus 1. The cloud management apparatus 1 specifies affected customers by specifying affected inter-VM communication and displays a specified result on a display apparatus used by the cloud provider 7. In FIG. 1, when a failure occurs in the link #4, the cloud management apparatus 1 specifies communication between the VM #1 and the VM #2 and communication between the VM #2 and the VM #3 as affected inter-VM communication. The cloud management apparatus 1 specifies customers affected by the failure based on correspondence information between the VMs 44 and customers.

The cloud management apparatus 1 manages, as the same group, the servers 41, all edge switches connected to which are the same, and manages communication paths among server groups. The edge switches are the switches 42 connected to the servers 41 by one link 43. In FIG. 1, all of the switches #1 to #4 are the edge switches.

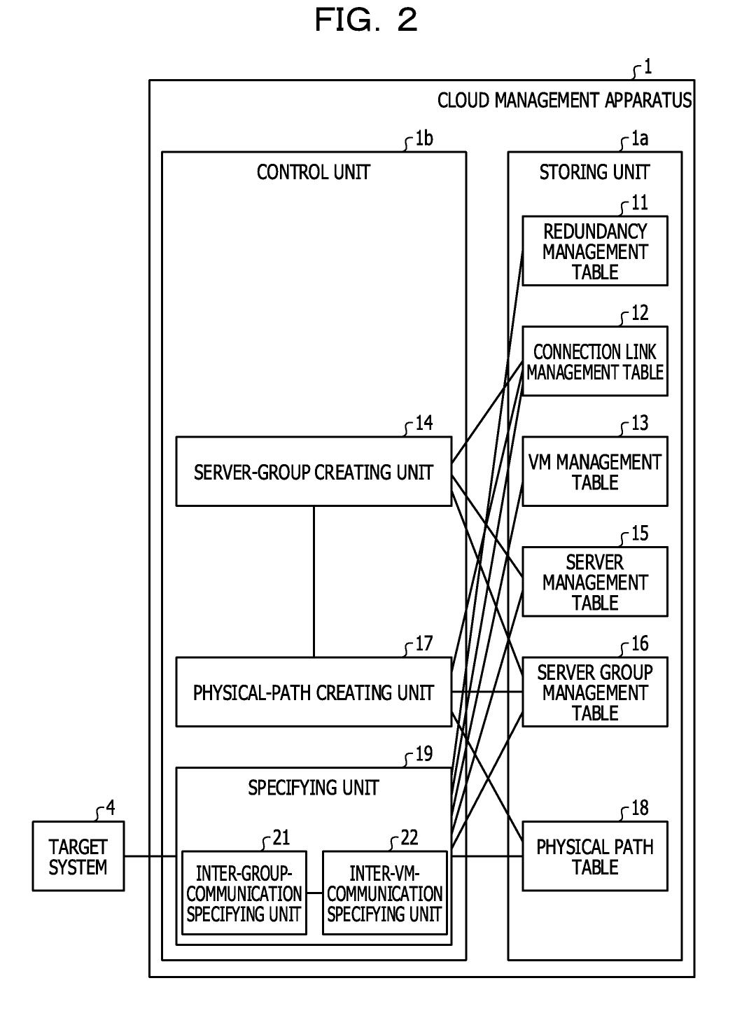

The cloud management apparatus 1 is explained. FIG. 2 is a diagram illustrating a functional configuration of the cloud management apparatus 1. As illustrated in FIG. 2, the cloud management apparatus 1 includes a storing unit 1a that stores data used for management of server groups, data used for an analysis of the influence of a failure, and the like and a control unit 1b that performs creation control of the data used for the management of the server groups, control of the analysis of the influence of the failure, and the like. The storing unit 1a stores a redundancy management table 11, a connection link management table 12, a VM management table 13, a server management table 15, a server group management table 16, and a physical path table 18. The control unit 1b includes a server-group creating unit 14, a physical-path creating unit 17, and a specifying unit 19.

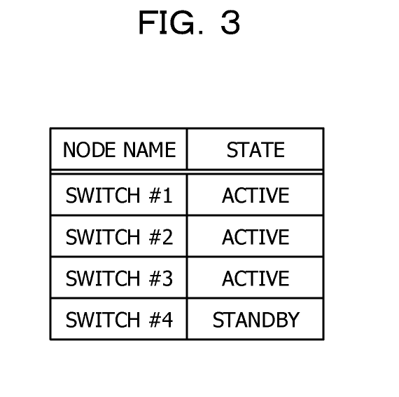

In the redundancy management table 11, information on redundant configurations of the information processing system 10 are registered. FIG. 3 is a diagram illustrating an example of the redundancy management table 11. As illustrated in FIG. 3, in the redundancy management table 11, a node name and a state are associated. The node name is an identifier for identifying the switch 42. The state indicates a state of use of the switch 42. When the state is “active”, the switch 42 is in use. When the state is “standby”, the switch 42 is not in use. For example, the switch #1 is in use and the switch #4 is not in use.

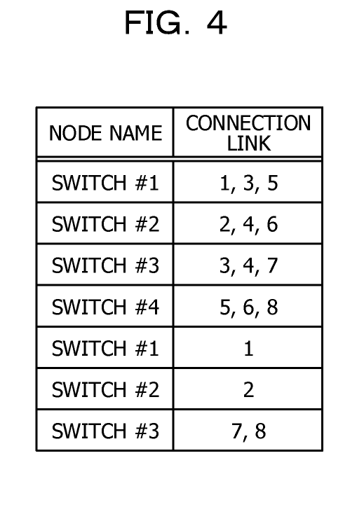

In the connection link management table 12, information on the links 43 connected to the switches 42 or the servers 41 is registered. FIG. 4 is a diagram illustrating an example of the connection link management table 12. As illustrated in FIG. 4, in the connection link management table 12, a node name and a connection link are associated. The node name is an identifier for identifying the switch 42 or an identifier for identifying the server 41. The connection link is an identification number for identifying the link 43 connected to the switch 42 or the server 41. For example, as the links 43 connected to the switch #1, there are the links #1, #3, and #5. As the link 43 connected to the server #1, there is the link #1. Note that a link #n is the link 43 having an identification number n.

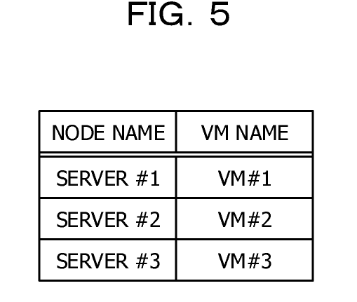

In the VM management table 13, the VMs 44 operating in the servers 41 are registered. FIG. 5 is a diagram illustrating an example of the VM management table 13. As illustrated in FIG. 5, in the VM management table 13, a node name and a VM name are associated. The node name is an identifier for identifying the server 41. The VM name is an identifier for identifying the VM 44. For example, the VM #1 operates in the server #1. The VM #2 operates in the server #2.

The server-group creating unit 14 groups the servers 41 referring to the connection link management table 12 and creates the server management table 15 and the server group management table 16. The server-group creating unit 14 groups the servers 41, all edge switches connected to which are the same, in the same group.

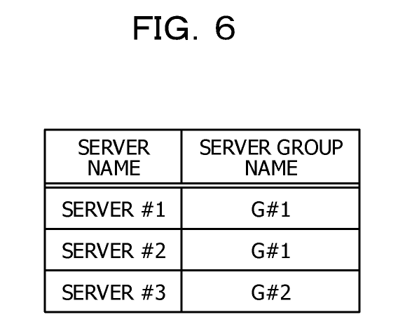

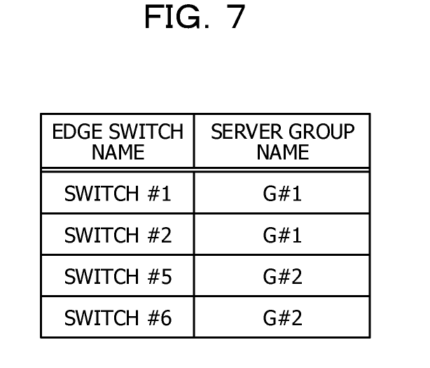

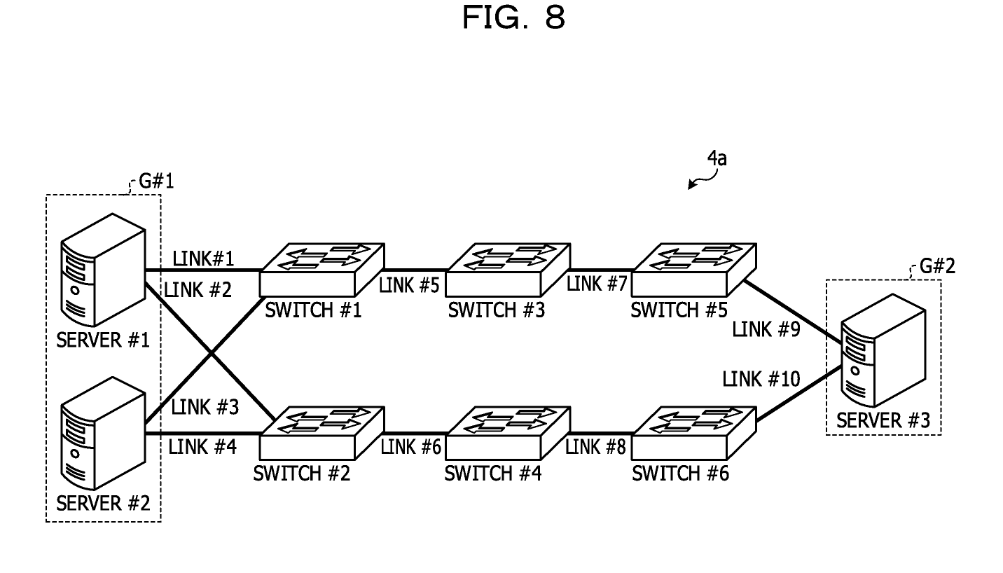

In the server management table 15, information on a server group is registered for each of the servers. In the server group management table 16, information on the edge switch to which the server group is connected is registered. FIG. 6 is a diagram illustrating an example of the server management table 15. FIG. 7 is a diagram illustrating an example of the server group management table 16. FIG. 8 is a diagram illustrating an example of a target system 4a used for creation of FIGS. 6 and 7.

As illustrated in FIG. 6, in the server management table 15, a server name and a server group name are associated. The server name is an identifier for identifying the server 41. The server group name is an identifier for identifying a server group. As illustrated in FIG. 7, in the server group management table 16, an edge switch name and a server group name are associated. The edge switch name is an identifier for identifying an edge switch. The server group name is an identifier for identifying a server group.

As illustrated in FIG. 8, in the target system 4a, the servers #1 and #2 are connected to the switches #1 and #2, which are the edge switches. All the connected edge switches are the same. Therefore, the servers #1 and #2 are included in a group having an identifier G#1. In FIG. 6, the servers #1 and #2 are associated with G#1. In FIG. 7, the switches #1 and #2 are associated with G#1.

As illustrated in FIG. 8, in the target system 4a, the server #3 is connected to the switches #5 and #6, which are the edge switches. There is no other server, all edge switches connected to which are the same. Therefore, the server #3 is included in a group having an identifier G#2. In FIG. 6, the server #3 is associated with G#2. In FIG. 7, the switches #5 and #6 are associated with G#2.

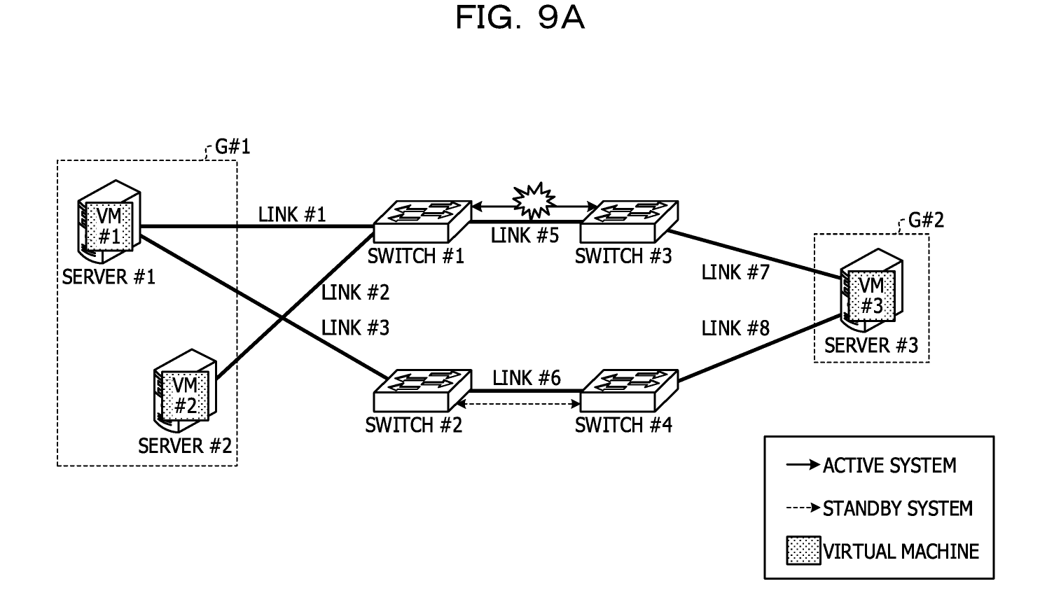

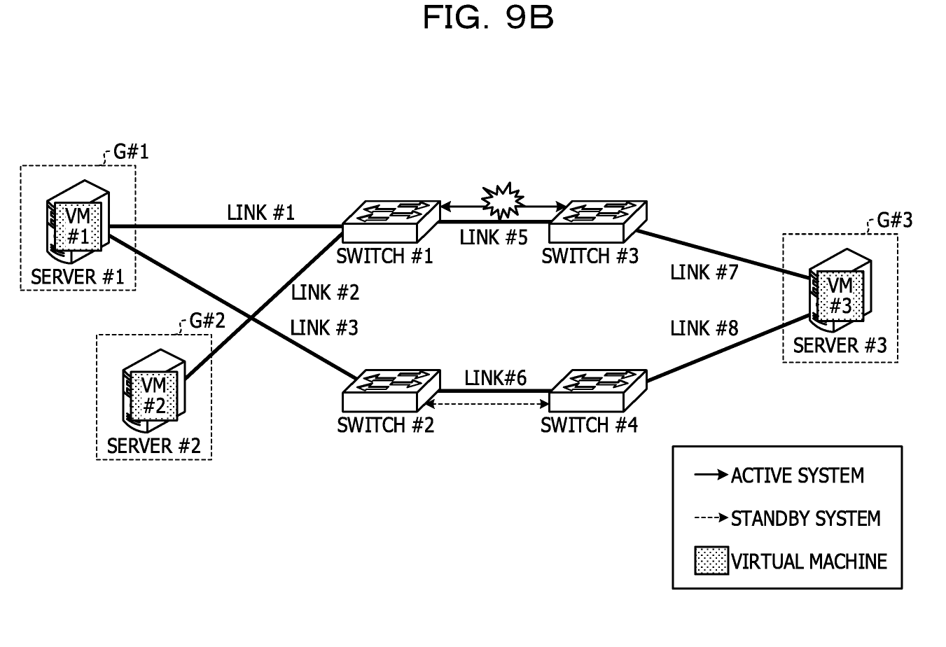

The server-group creating unit 14 performs group allocation under a policy of allocating the servers 41, all edge switches connected to which are the same, to the same group. On the other hand, a policy of allocating all the servers 41 subordinate to a switch to the same group is also conceivable. FIG. 9A is a diagram illustrating an example 1 of group allocation for allocating all the servers 41 subordinate to a switch to the same group. FIG. 9B is a diagram illustrating an example 2 of the group allocation for allocating the servers 41, all edge switches connected to which are the same, to the same group.

As illustrated in FIG. 9A, in the example 1 of the group allocation, the servers #1 and #2 subordinate to the switch #1 are allocated to the same group G#1. Subsequently, a group is about to be allocated to the server #1 subordinate to the switch #2. However, since the group G#1 is already allocated to the server #1, new allocation to the server #1 is not performed. Subsequently, the group G#2 is allocated to the server #3 subordinate to the switch #3. Subsequently, a group is about to be allocated to the server #3 subordinate to the switch #4. However, since the group G#2 is already allocated to the server #3, new allocation to the server #3 is not performed.

When a failure occurs in the link #5, the server #1 is not affected because a path passing through the link #6 is present in communication with the server #3. However, the server #2 is affected because another path is absent in communication with the server #3. That is, in the example 1 of the group allocation, the servers 41 different in presence or absence of influence are present in the same group G#1.

On the other hand, as illustrated in FIG. 9B, in the example 2 of the group allocation, the server #1 is connected to the switches #1 and #2, the server #2 is connected to the switch #1, and the server #3 is connected to the switches #3 and #4. That is, all edge switches connected to the servers #1 to #3 are different. Therefore, different groups G#1 to G#3 are respectively allocated to the servers #1 to #3.

When a failure occurs in the link #5, the server #1 is not affected because a path passing through the link #6 is present in communication with the server #3. However, the server #2 is affected because another path is absent in communication with the server #3. However, since different groups are allocated to the servers #1 and #2, the servers 41 different in the presence or absence of influence is absent in the same group. In this way, by allocating the servers 41, all the edge switches connected to which are the same, to the same group, the server-group creating unit 14 may cause all the servers 41 in the same group to be affected the same by a failure.

The server-group creating unit 14 creates a server group by performing the following (1) to (5) on all the edge switches.

(1) Select one edge switch.

(2) Extract the server 41 adjacent to the edge switch selected in (1) and not allocated with a server group, allocate a server group to the server 41, and extract all edge switches to which the extracted server 41 is connected.

(3) Extract another server 41 adjacent to the edge switch selected in (1) and not allocated with a server group and extract all edge switches to which the extracted other server 41 is connected.

(4) Compare the edge switches extracted in (2) and the edge switches extracted in (3) and, when all the edge switches are the same, allocate the server group allocated in (2) to the other server 41.

(5) Repeat (3) and (4) until no more server 41 adjacent to the selected edge switch is left and repeats (1) to (4) until no edge switch is left.

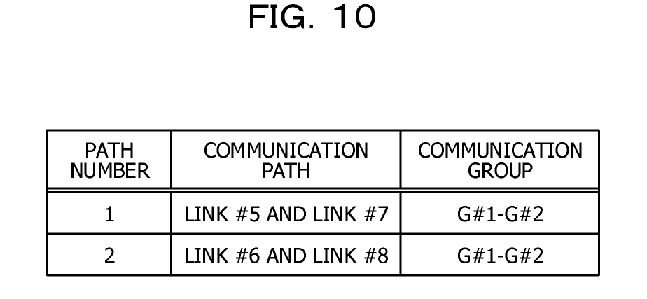

The physical-path creating unit 17 specifies, referring to the connection link management table 12 and the server group management table 16, a set of the links 43 connecting two edge switches as a physical path and creates the physical path table 18. The physical path and two server groups that perform communication using the physical path are registered in the physical path table 18. FIG. 10 is a diagram illustrating an example of the physical path table 18. FIG. 10 is the physical path table 18 created targeting the target system 4a illustrated in FIG. 8.

As illustrated in FIG. 10, in the physical path table 18, a path number, a communication path, and a communication group are associated. The path number is an identification number for identifying a physical path. The communication path is a set of identifiers of the links 43 included in the physical path. The communication group is an identifier of two server groups that communicate using the physical path. For example, the “link #5” and the “link #7” are included in a physical path having a path number “1”. The physical path is used in communication between “G#1” and “G#2”.

The physical-path creating unit 17 specifies all physical paths by retrieving, for all the edge switches, a path from an edge switch to another edge switch. The physical-path creating unit 17 extracts server groups subordinate to edge switches at both ends of the physical paths referring to the server group management table 16, creates a combination of the server groups, and registers the combination in the physical path table 18 in association with the physical paths.

The specifying unit 19 specifies inter-VM communication affected by an occurred failure. The specifying unit 19 includes an inter-group-communication specifying unit 21 and an inter-VM-communication specifying unit 22.

The inter-group-communication specifying unit 21 specifies inter-server group communication affected by the occurred failure. That is, the inter-group-communication specifying unit 21 specifies a physical path affected by the occurred failure referring to the physical path table 18 and determines whether the specified physical path is active referring to the redundancy management table 11 and the connection link management table 12. When the specified physical path is active, the inter-group-communication specifying unit 21 specifies, referring to the physical path table 18, inter-server group communication corresponding to the physical path and determines whether another physical path is present in the specified inter-server group communication. The inter-group-communication specifying unit 21 specifies inter-server group communication without another physical path in the specified inter-server group communication as inter-server group communication affected by the occurred failure.

The inter-VM-communication specifying unit 22 specifies inter-server communication affected by the failure from the inter-server group communication specified by the inter-group-communication specifying unit 21 and specifies inter-VM communication affected by the failure from the specified inter-server communication. That is, the inter-VM-communication specifying unit 22 respectively extracts, referring to the server management table 15, the servers 41 in two server groups set as targets of the inter-server group communication specified by the inter-group-communication specifying unit 21. The inter-VM-communication specifying unit 22 creates a combination of the servers 41 between different server groups and specifies inter-VM communication affected by the occurred failure referring to the VM management table 13.

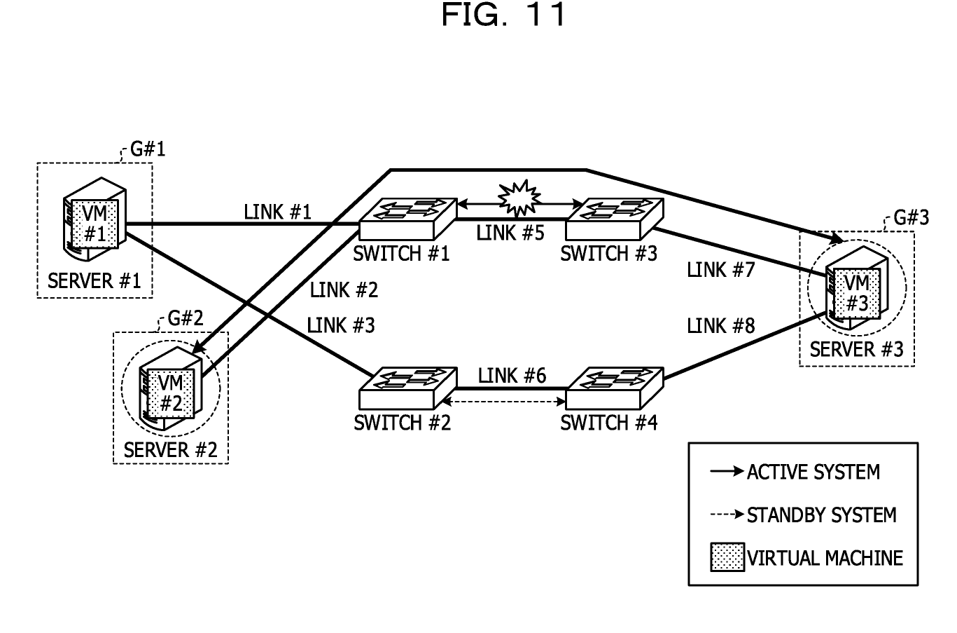

In this way, the specifying unit 19 specifies affected inter-VM communication considering whether a physical path affected by the occurred failure is active and, when the physical path is active, considering whether redundant paths are present for affected inter-server group communication or inter-server communication. FIG. 11 is a diagram illustrating an example of specifying an influence range considering redundant paths. As illustrated in FIG. 11, when a failure occurs in the link #5, a physical path including the link #5 is active. Therefore, communication between the server groups G#1 and G#3 and communication between the server groups G#2 and G#3 are extracted as affected inter-server group communication.

The communication between the server groups G#1 and G#3 is not affected by the failure because a standby path passing through the link #6 is present. On the other hand, in the communication between the server groups G#2 and G#3, communication between the servers #2 and #3 is affected by the failure because a standby path is absent. The communication between the VMs #2 and #3 is specified as affected inter-VM communication.

When a failure occurs in a physical path between the server 41 and an edge switch, the inter-group-communication specifying unit 21 specifies a physical path passing through an edge switch connected to a failure part referring to the communication link management table 12 and the physical path table 18. The inter-group-communication specifying unit 21 determines whether the specified physical path is active referring to the redundancy management table 11 and the connection link management table 12. When the specified physical path is active, the inter-group-communication specifying unit 21 specifies inter-server group communication in which the specified physical path is used. However, the inter-server group communication to be specified is communication including a server group to which the server 41 connected to the failure part belongs.

The inter-group-communication specifying unit 21 determines whether another physical path is present in the specified inter-server group communication referring to the physical path table 18. The inter-group-communication specifying unit 21 specifies, as inter-server group communication affected by the occurred failure, inter-server group communication without another physical path in the specified inter-server group communication.

The inter-VM communication specifying unit 22 respectively extracts, referring to the server management table 15, the servers 41 in two server groups set as targets of the inter-server group communication specified by the inter-group-communication specifying unit 21. However, the inter-VM communication specifying unit 22 extracts only the server 41 connected to the failure part from the server group to which the server 41 connected to the failure part belongs. The inter-VM communication specifying unit 22 creates a combination of the servers 41 between the server groups and specifies inter-VM communication affected by the occurred failure referring to the VM management table 13.

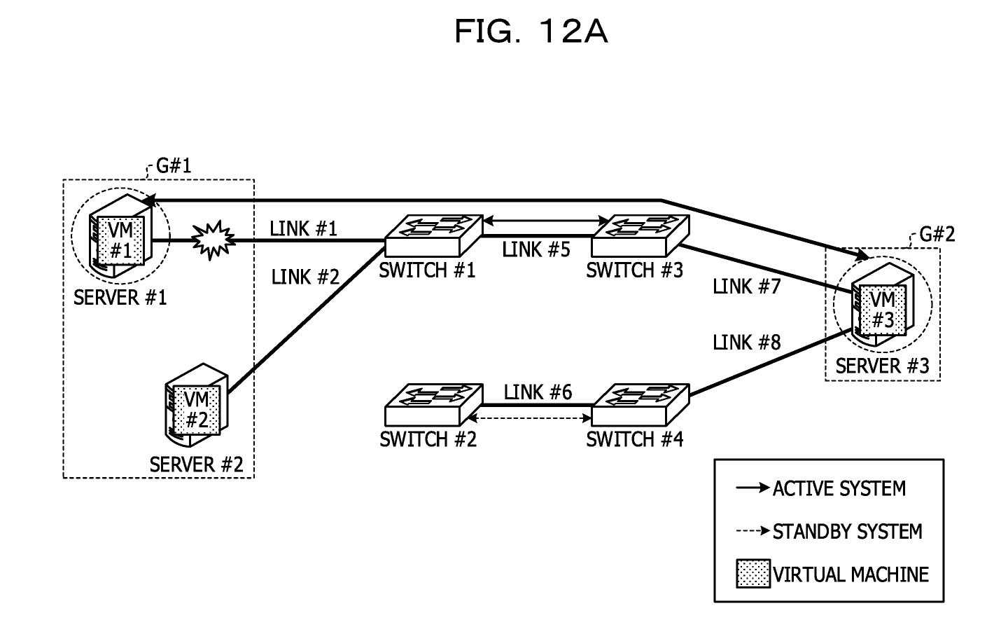

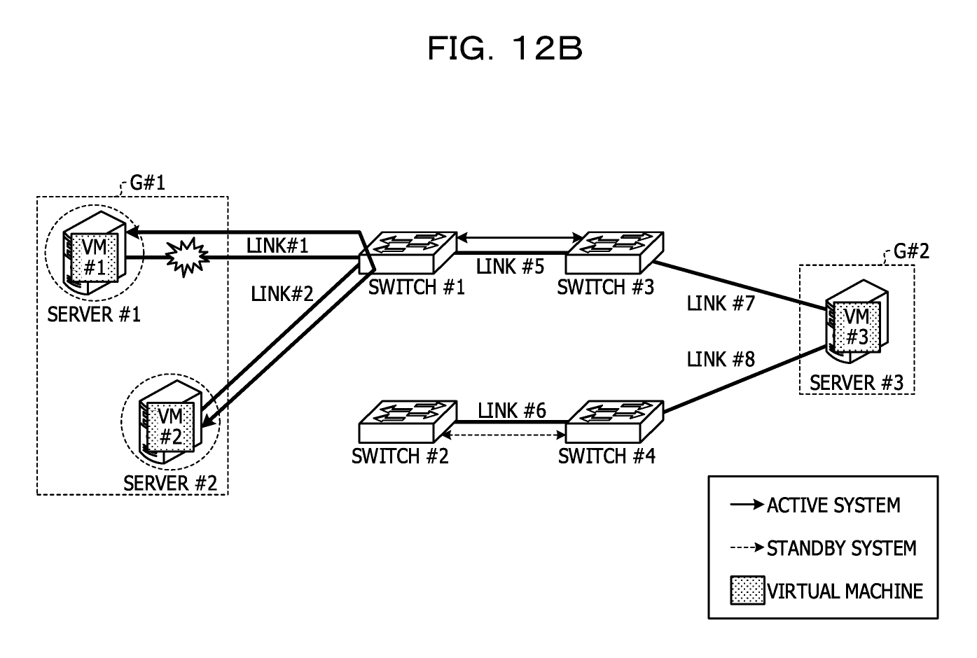

FIG. 12A is a first diagram illustrating an example of specifying an influence range when a failure occurs in a path between the server 41 and an edge switch. As illustrated in FIG. 12A, when a failure occurs in the link #1, communication between the server groups G#1 and G#2 is specified as affected active inter-server group communication. Since another path is absent between the server groups G#1 and G#2, the server #1 connected to the link #1 in which the failure occurs is extracted from the server group G#1. The server #3 is extracted from the server group G#2. Inter-VM communication between the VM #1 constructed by the server #1 and the VM #3 constructed by the server #3 is specified as inter-VM communication affected by the failure.

When a failure occurs in the path between the server 41 and the edge switch, the inter-VM-communication specifying unit 22 extracts, in a server group to which the server 41 connected to a failure part belongs, a physical path of affected inter-server communication. The inter-VM-communication specifying unit 22 determines whether the extracted physical path is active referring to the redundancy management table 11 and the connection link management table 12. When the extracted physical path is active, the inter-VM-communication specifying unit 22 determines whether another path is present referring to the redundancy management table 11 and the connection link management table 12. When another path is absent, the inter-VM-communication specifying unit 22 extracts the VM 44 constructed by the server 41 set as a target of the affected inter-server communication and specifies a combination of VMs on different servers as affected inter-VM communication.

FIG. 12B is a second diagram illustrating the example of specifying an influence range when a failure occurs in the path between the server 41 and the edge switch. As illustrated in FIG. 12B, when a failure occurs in the link #1, communication between the servers #1 and #2 is extracted as affected inter-server communication. Since the communication between the servers #1 and #2 is active and another path is absent, the VM #1 constructed by the server #1 and the VM #2 constructed by the server #2 are extracted. Communication between the VMs #1 and #2 is specified as affected inter-VM communication.

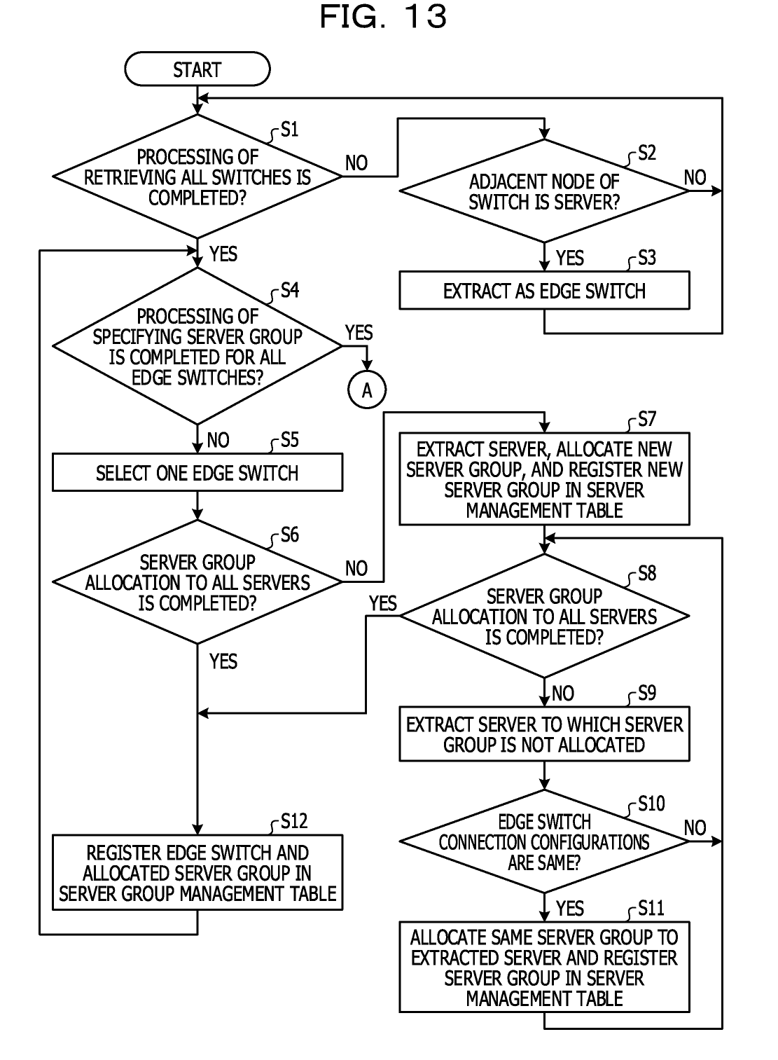

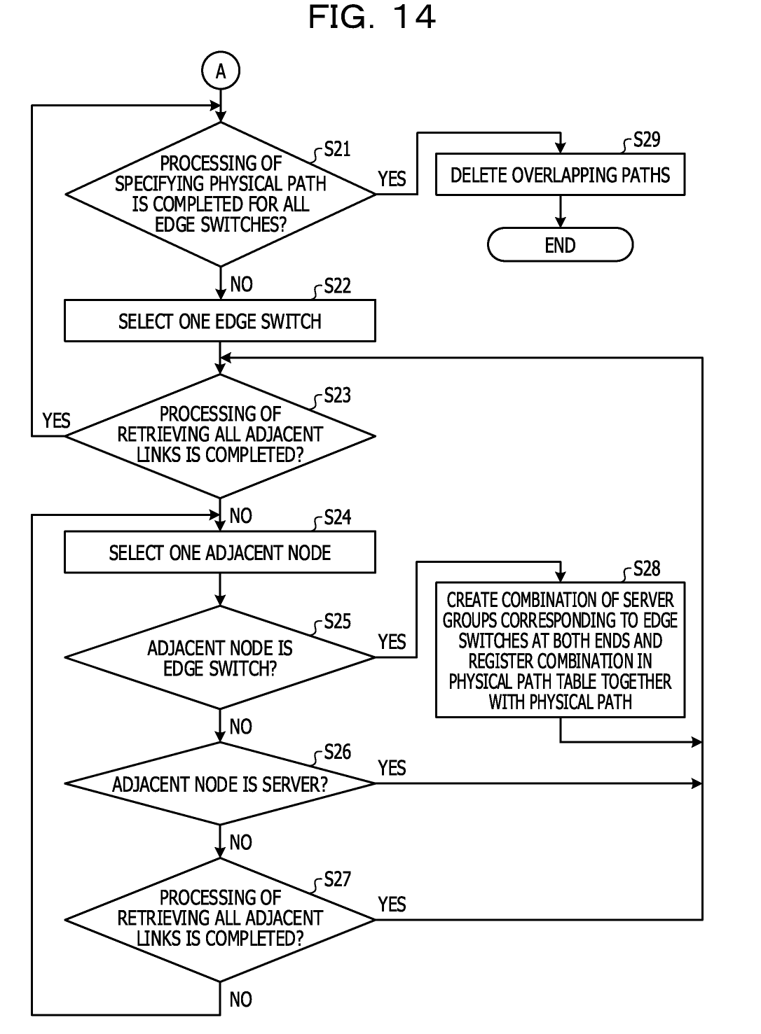

A flow of processing of creating a server group and creating the physical path table 18 is explained. FIG. 13 is a flowchart illustrating a flow of processing of creating a server group. FIG. 14 is a flowchart illustrating a flow of processing of creating the physical path table 18. Note that the creation of a server group is performed after construction of an information processing system. The creation of a server group is also performed when a network configuration is changed or when a server configuration is changed.

As illustrated in FIG. 13, the server-group creating unit 14 determines whether processing of retrieving all the switches 42 from the connection link management table 12 is completed (step S1). When the switches 42 not retrieved are present, the server-group creating unit 14 retrieves one switch 42 and determines whether an adjacent node of the retrieved switch 42 is the server 41 (step S2). When the adjacent node is not the server 41, the server-group creating unit 14 returns to step S1. When the adjacent node is the server 41, the server-group creating unit 14 extracts the retrieved switch 42 as an edge switch (step S3) and returns to step S1.

On the other hand, when the processing of retrieving all the switches 42 is completed, the server-group creating unit 14 determines whether processing of specifying a server group is completed for all the edge switches (step S4). As a result, when edge switches on which the processing of specifying a server group is not performed are present, the server-group creating unit 14 selects one edge switch (step S5). The server-group creating unit 14 determines whether the server group allocation to all servers subordinate to the selected edge switch is completed (step S6).

When the server 41 on which the server group allocation is not performed is present, the server-group creating unit 14 extracts the server 41 to which a server group is not allocated, allocates a new server group to the server 41, and registers the new server group in the server management table 15 (step S7). The server-group creating unit 14 determines whether the server group allocation to all the servers subordinate to the selected edge switch is completed (step S8).

When the server 41 on which the server group allocation is not performed is present, the server-group creating unit 14 extracts the server 41 to which a server group is not allocated (step S9). The server-group creating unit 14 determines whether edge switch connection configurations of the extracted server 41 and the server 41 to which the server group is allocated in step S7 are the same (step S10). As a result, when the edge switch connection configurations are the same, the server-group creating unit 14 allocates the same server group to the extracted server 41 and registers the server group in the server management table 15 (step S11) and returns to step S8. When the edge switch connection configurations are not the same, the server-group creating unit 14 returns to step S8.

When determining in step S8 that the server group allocation to all the servers is completed, the server-group creating unit 14 registers the selected edge switches and the allocated server groups in the server group management table 16 (step S12). When determining in step S6 that the server group allocation to all the servers is completed, the server-group creating unit 14 also registers the selected edge switches and the allocated server groups in the server group management tables 16 (step S12). The server-group creating unit 14 returns to step S4.

When determining in step S4 that the processing of specifying a server group is completed for all the edge switches, the server-group creating unit 14 ends the processing. The physical-path creating unit 17 starts the processing of creating the physical path table 18.

As illustrated in FIG. 14, the physical-path creating unit 17 determines whether processing of specifying a physical path is completed for all the edge switches (step S21). As a result, when edge switches on which the processing of specifying a physical path is not performed is present, the physical-path creating unit 17 selects one edge switch (step S22). The physical-path creating unit 17 determines whether processing of retrieving all adjacent links is completed for the selected edge switch (step S23). When adjacent links not retrieved are present, the physical-path creating unit 17 selects one adjacent node (step S24).

The physical-path creating unit 17 determines whether the selected adjacent node is an edge switch (step S25). When the selected adjacent node is not an edge switch, the physical-path creating unit 17 determines whether the adjacent node is the server 41 (step S26). As a result, when the adjacent node is not the server 41, the physical-path creating unit 17 determines whether the processing of retrieving all adjacent links is completed for the adjacent node (step S27). When adjacent links not retrieved are present, the physical-path creating unit 17 returns to step S24.

On the other hand, when the processing of retrieving all adjacent links is completed for the adjacent node or when the adjacent node is the server 41, the physical-path creating unit 17 returns to step S23. When determining in step S25 that the adjacent node is an edge switch, the physical-path creating unit 17 creates a combination of server groups corresponding to edge switches at both ends of the retrieved physical path and registers the combination in the physical path table 18 together with the physical path (step S28). The physical-path creating unit 17 returns to step S23.

When determining in step S23 that the processing of retrieving all adjacent links is completed, the physical-path creating unit 17 returns to step S21. When determining in step S21 that the processing of specifying a physical path is completed for all the edge switches, the physical-path creating unit 17 deletes overlapping paths from the physical path table 18 (step S29) and ends the processing of creating the physical path table 18.

In this way, the server-group creating unit 14 creates a server group and the physical-path creating unit 17 creates the physical path table 18 based on the server group. Consequently, the specifying unit 19 may specify an influence range of a failure referring to the physical path table 18.

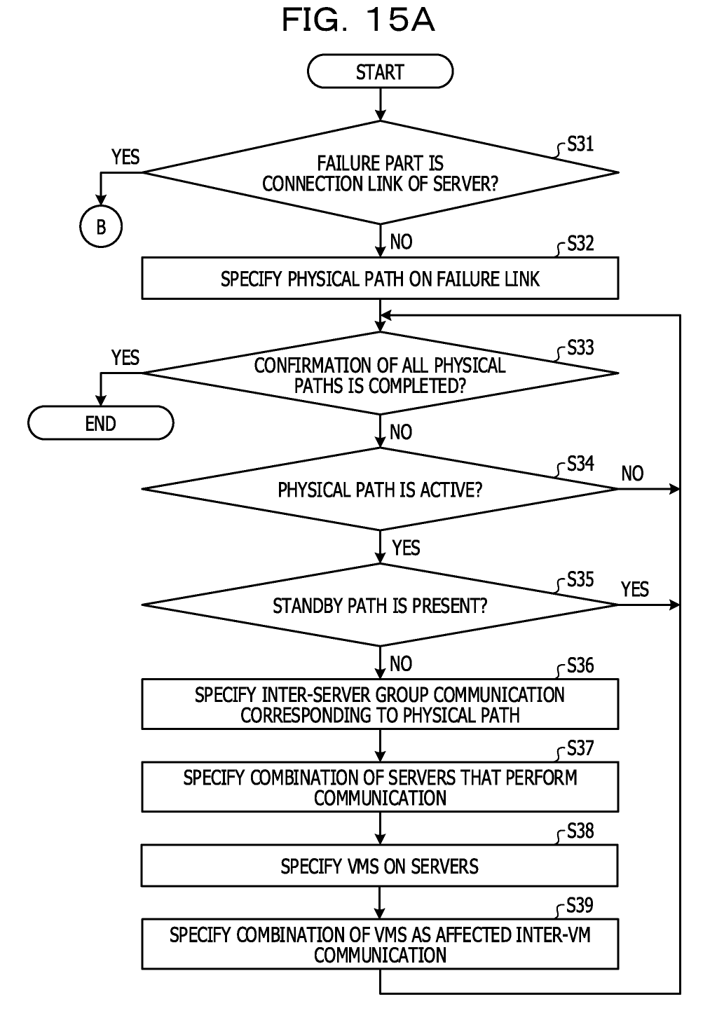

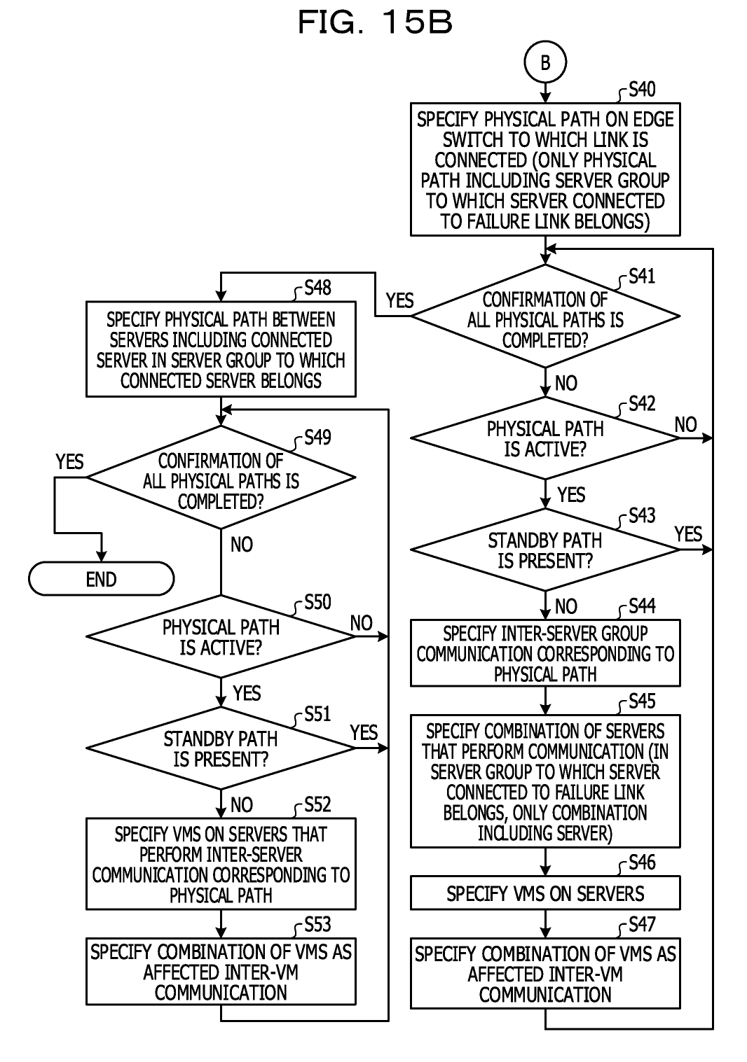

A flow of processing of specifying an influence range is explained. FIG. 15A is a first flowchart illustrating the flow of the processing of specifying an influence range. FIG. 15B is a second flowchart illustrating the flow of the processing of specifying an influence range. Note that the processing of specifying an influence range is started when the specifying unit 19 receives a failure occurrence notification.

As illustrated in FIG. 15A, the specifying unit 19 determines whether a failure part is a connection link of the server 41 (step S31). When the failure part is not the connection link of the server 41, the specifying unit 19 specifies a physical path on a failure link (step S32). The specifying unit 19 determines whether confirmation of all physical paths is completed (step S33). When the confirmation of all the physical paths is completed, the specifying unit 19 ends the processing.

On the other hand, when physical paths not confirmed are present, the specifying unit 19 determines whether one of the specified physical paths is active (step S34). When the physical path is not active, the specifying unit 19 returns to step S33. On the other hand, when the physical path is active, the specifying unit 19 determines whether a standby path is present (step S35). When a standby path is present, the specifying unit 19 returns to step S33.

On the other hand, when a standby path is absent, the specifying unit 19 specifies inter-server group communication corresponding to the physical path (step S36) and specifies a combination of the servers 41 that perform communication based on the specified inter-server group communication (step S37). The specifying unit 19 specifies the VMs 44 on the specified servers (step S38) and specifies a combination of the specified VMs 44 as affected inter-VM communication (step S39). The specifying unit 19 returns to step S33.

When determining in step S31 that the failure part is the connection link of the server 41, as illustrated in FIG. 15B, the specifying unit 19 specifies a physical path on an edge switch to which the link 43 is connected (step S40). However, the specifying unit 19 specifies only a physical path including a server group to which the server 41 connected to the failure link belongs.

The specifying unit 19 determines whether the confirmation of all the physical paths is completed (step S41). When physical paths not confirmed are present, the specifying unit 19 determines whether one of the specified physical paths is active (step S42). When the physical path is not active, the specifying unit 19 returns to step S41. On the other hand, when the physical path is active, the specifying unit 19 determines whether a standby path is present (step S43). When a standby path is present, the specifying unit 19 returns to step S41.

On the other hand, when a standby path is absent, the specifying unit 19 specifies inter-server group communication corresponding to the physical path (step S44) and specifies a combination of the servers 41 that perform communication based on the specified inter-server group communication (step S45). However, in a server group to which the server 41 connected to the failure link belongs, the specifying unit 19 specifies only a combination including the server 41 connected to the failure link. The specifying unit 19 specifies the VMs 44 on the specified servers (step S46) and specifies a combination of the specified VMs 44 as affected inter-VM communication (step S47).

When determining in step S41 that the confirmation of all the physical paths is completed, the specifying unit 19 specifies a physical path among servers including a connected server, which is connected to the failure link, in the server group to which the connected server belongs (step S48). The specifying unit 19 determines whether the confirmation of all the physical paths is completed (step S49). When the confirmation of all the physical paths is completed, the specifying unit 19 ends the processing.

On the other hand, when physical paths not confirmed are present, the specifying unit 19 determines whether one of the specified physical paths is active (step S50). When the physical path is not active, the specifying unit 19 returns to step S49. On the other hand, when the physical path is active, the specifying unit 19 determines whether a standby path is present (step S51). When a standby path is present, the specifying unit 19 returns to step S49.

On the other hand, when a standby path is absent, the specifying unit 19 specifies the VMs 44 on the servers that perform inter-server communication corresponding to the physical path (step S52) and specifies a combination of the specified VMs 44 as affected inter-VM communication (step S53).

In this way, the specifying unit 19 specifies affected inter-server group communication, specifies affected inter-server communication based on the specified inter-server group communication, and specifies affected inter-VM communication based on the specified inter-server communication. Therefore, the specifying unit 19 may reduce a time taken for the processing of specifying affected inter-VM communication.

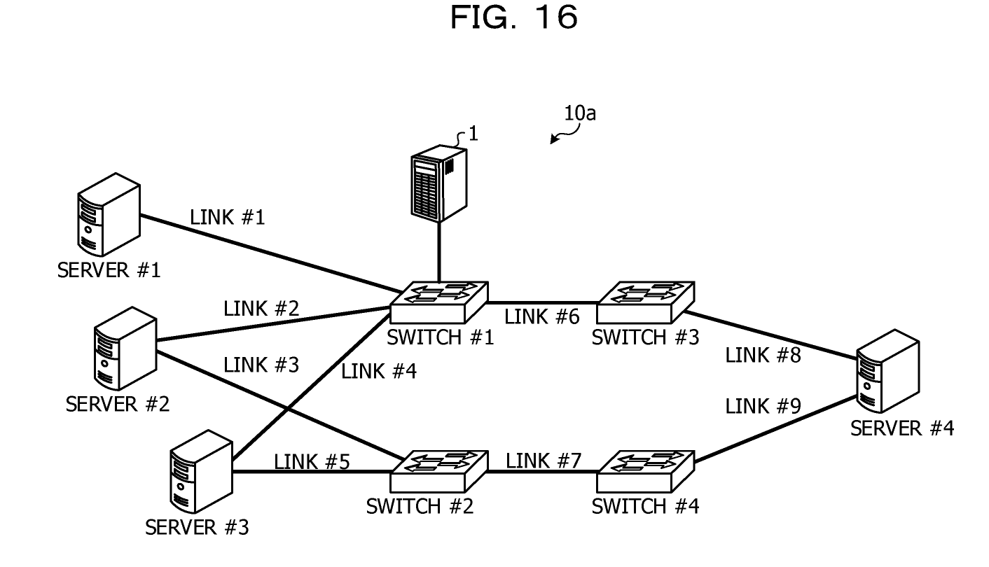

An example of specifying an influence range is explained with reference to FIGS. 16 to 25. FIG. 16 is a diagram illustrating an information processing system 10a used for the explanation of the example of specifying an influence range. As illustrated in FIG. 16, the information processing system 10a includes the cloud management apparatus 1, the four servers #1 to #4, and the four switches #1 to #4. The switches #2 and #4 are standby switches.

The server #1 is connected to the switch #1 by the link #1. The server #2 is connected to the switch #1 by the link #2 and connected to the switch #2 by the link #3. The server #3 is connected to the switch #1 by the link #4 and connected to the switch #2 by the link #5. The switches #1 and #3 are connected by the link #6. The switches #2 and #4 are connected by the link #7. The server #4 is connected to the switch #3 by the link #8 and connected to the switch #4 by a link #9.

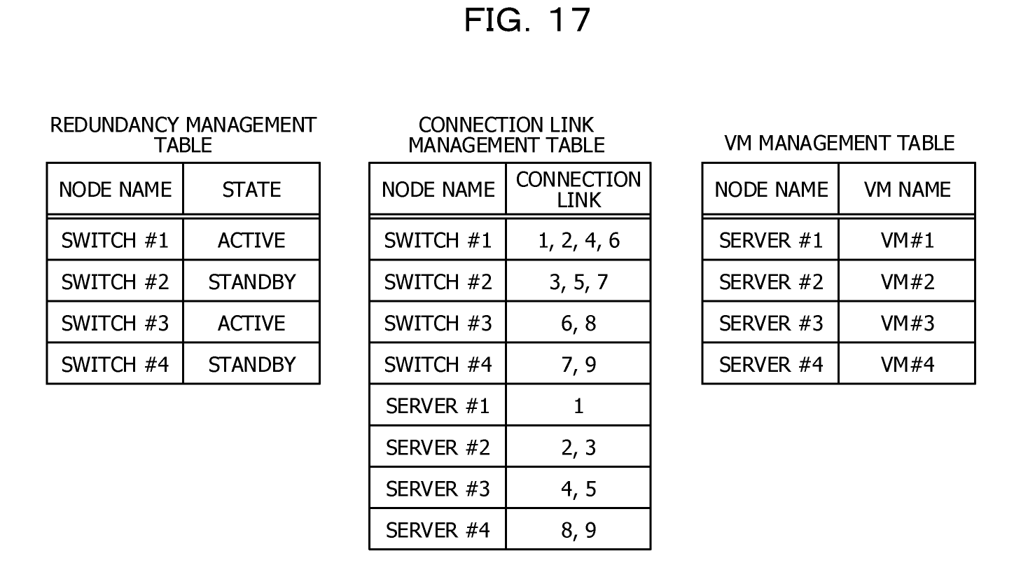

FIG. 17 is a diagram illustrating the redundancy management table 11, the connection link management table 12, and the VM management table 13 corresponding to the information processing system 10a illustrated in FIG. 16. As illustrated in FIG. 17, the switches #1 and #3 are registered in the redundancy management table 11 as “active”. The switches #2 and #4 are registered in the redundancy management table 11 as “standby”.

Connection of the switch #1 to the links #1, #2, #4, and #6 and connection of the switch #2 to the links #3, #5, and #7 are registered in the connection link management table 12. Connection of the switch #3 to the links #6 and #8 and connection of the switch #4 to the links #7 and #9 are registered in the connection link management table 12. Connection of the server #1 to the link #1, connection of the server #2 to the links #2 and #3, connection of the server #3 to the links #4 and #5, and connection of the server #4 to the links #8 and #9 are registered in the connection link management table 12.

Operation of the VM #1 on the server #1, operation of the VM #2 on the server #2, operation of the VM #3 on the server #3, and operation of the VM #4 on the server #4 are registered in the VM management table 13.

First, the physical-path creating unit 17 creates the server management table 15 and the server group management table 16. That is, the physical-path creating unit 17 extracts the servers #1, #2, and #3 as the servers 41 subordinate to the switch #1 based on the connection link management table 12. The physical-path creating unit 17 allocates the server group #1 to the server #1 and allocates the server group #2 to the servers #2 and #3. The physical-path creating unit 17 registers the allocated server groups subordinate to the switch #1 in the server management table 15 and the server group management table 16.

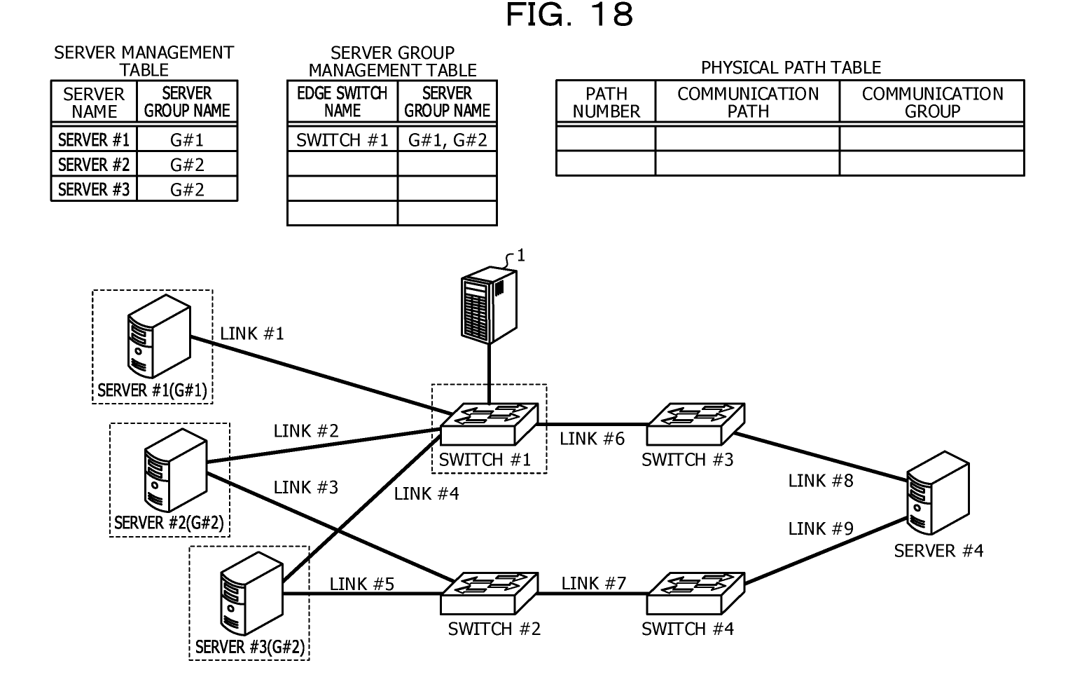

FIG. 18 is a diagram illustrating states of the server management table 15 and the server group management table 16 at the time when the server groups subordinate to the switch #1 are registered. As illustrated in FIG. 18, the servers #1, #2, and #3 are registered in the server management table 15 with the server group G#1 associated with the server #1 and the server group G#2 associated with the servers #2 and #3. The switch #1 is registered in the server group management table 16 with the server groups G#1 and G#2 associated with the switch #1.

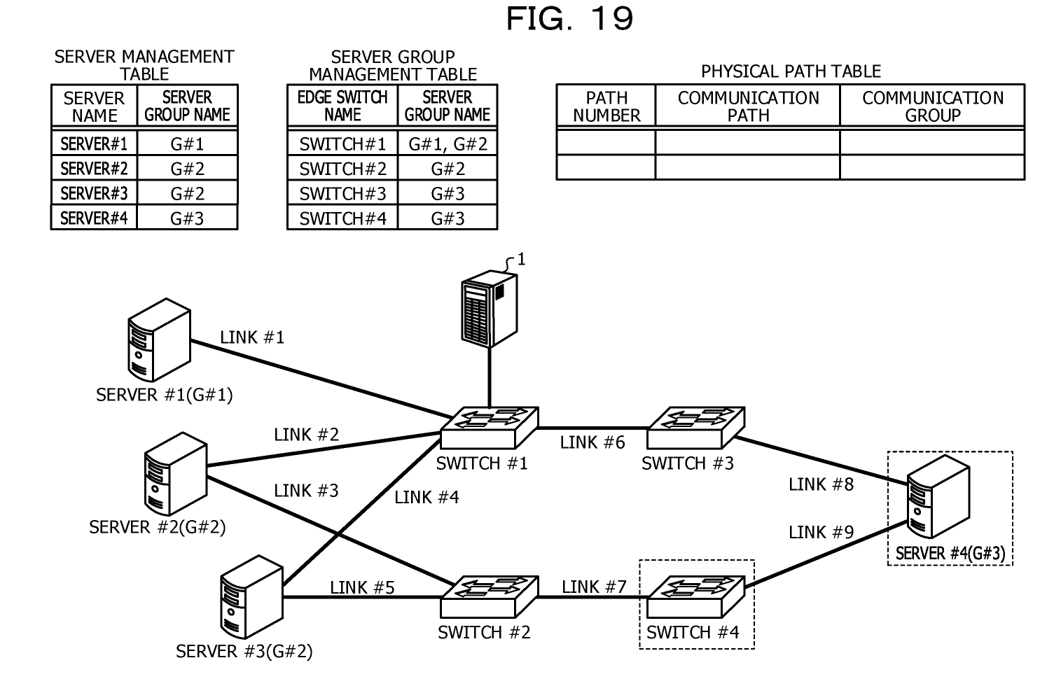

The physical-path creating unit 17 performs the same processing for the switches #2, #3, and #4 to allocate the server group G#3 to the server #4. FIG. 19 is a diagram illustrating states of the server management table 15 and the server group management table 16 at the time when server groups subordinate to the switches #2 to #4 are registered. As illustrated in FIG. 19, the server #4 is registered in the server management table 15 with the server group G#3 associated with the server #4. The switches #2, #3, and #4 are registered in the server group management table 16 with the server group G#2 associated with the switch #2 and the server group G#3 associated with the switches #3 and #4.

Subsequently, the physical-path creating unit 17 creates the physical path table 18. That is, the physical-path creating unit 17 extracts the servers #1, #2, and #3 and the switch #3 as adjacent nodes of the switch #1 based on the connection link management table 12. Only a physical path from the switch #1 to the switch #3 is a physical path from an edge switch to an edge switch. Therefore, the physical-path creating unit 17 registers the link #6 from the switch #1 to the switch #3 in the physical path table 18 as a communication path of a path #1. The physical-path creating unit 17 specifies the server groups G#1 and G#2 as server groups associated with the switch #1 and specifies the server group G#3 as a server group associated with the switch #3 referring to the server group management table 16. The physical-path creating unit 17 registers G#1-G#3 and G#2-G#3 in the physical path table 18 as communication groups corresponding to the path #1.

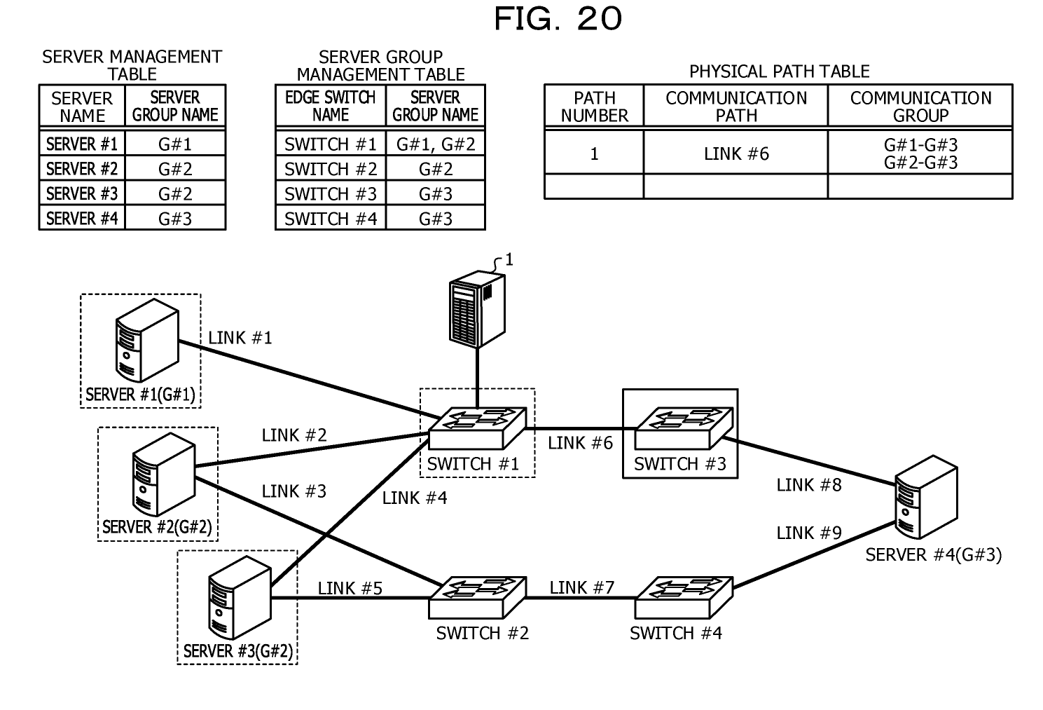

FIG. 20 is a diagram illustrating a state of the physical path table 18 at the time when the path #1 is registered. As illustrated in FIG. 20, inter-server group communications “G#1-G#3” and “G#2-G#3” are associated with the physical path “link #6” having a path number “1”.

The physical-path creating unit 17 performs the same processing for the switches #2, #3, and #4 and respectively registers, in the physical path table 18, a path #2 with the link #7 set as a physical path, a path #3 with the link #6 set as a physical path, and a path #4 with the link #7 set as a physical path.

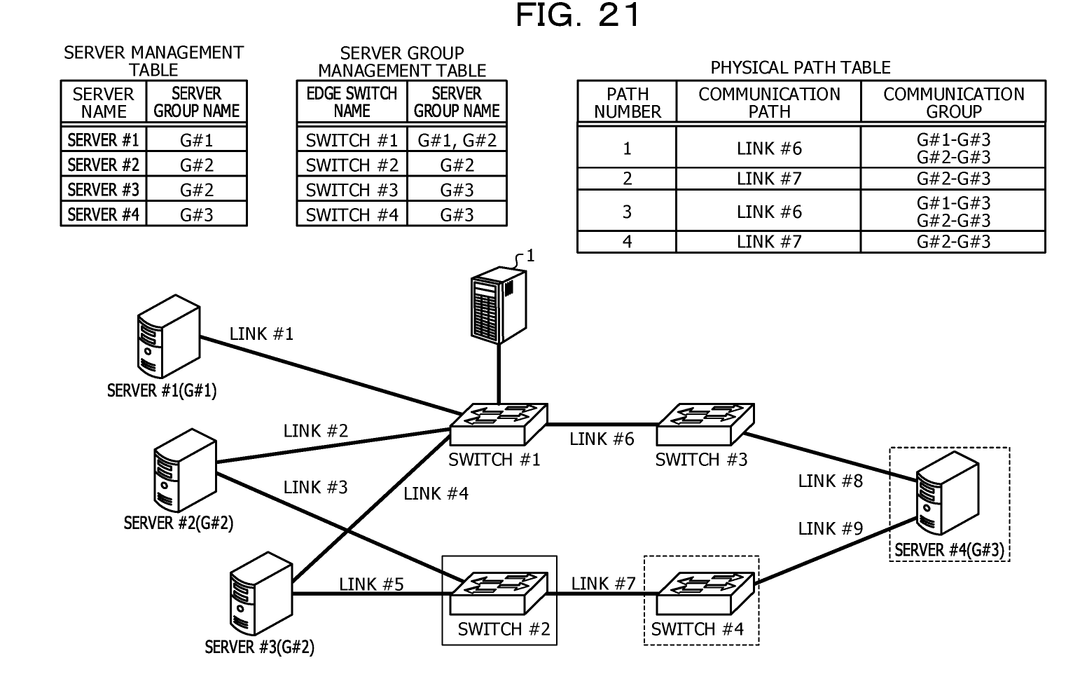

FIG. 21 is a diagram illustrating a state of the physical path table 18 at the time when the paths #2 to #4 are registered. As illustrated in FIG. 21, the inter-server group communication “G#2-G#3” is associated with the physical path “link #7” having a path number “2”. The inter-server group communications “G#1-G#3” and “G#2-G#3” are associated with the physical path “link #6” having a path number “3”. The inter-server group communication “G#2-G#3” is associated with the physical path “link #7” having a path number “4”.

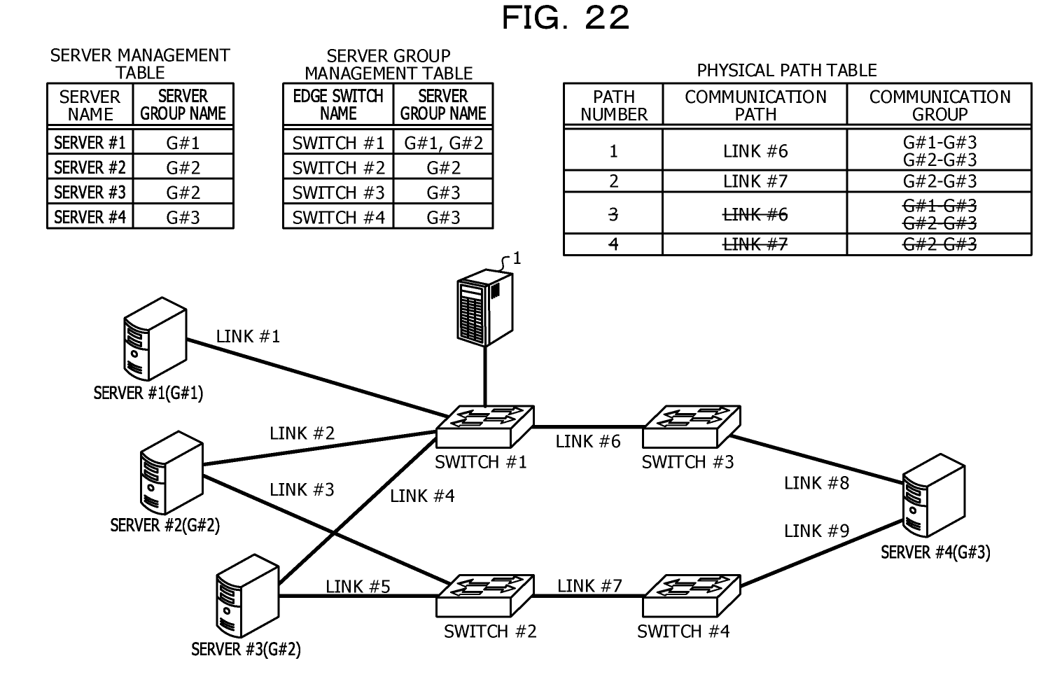

Subsequently, the physical-path creating unit 17 deletes overlapping physical paths from the physical path table 18. In FIG. 21, since communication paths of the paths #1 and #3 are the same, the path #3 is deleted and, since communication paths of the paths #2 and #4 are the same, the path #4 is deleted. FIG. 22 is a diagram illustrating a state of the physical path table 18 at the time when the overlapping paths are deleted. As illustrated in FIG. 22, the paths #3 and #4 are deleted from the physical path table 18 illustrated in FIG. 21.

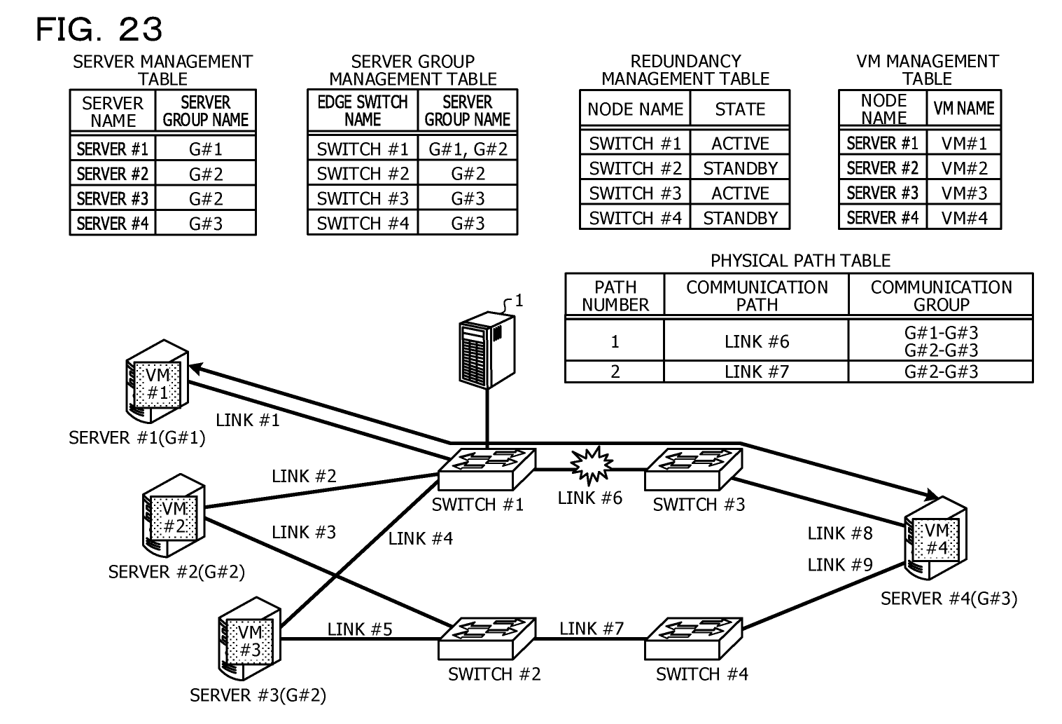

When a failure occurs, the specifying unit 19 specifies inter-VM communication affected by a failure. FIG. 23 is a diagram illustrating a state at the time when a failure occurs between switches. In FIG. 23, a failure occurs in the link #6. As illustrated in FIG. 23, during the failure occurrence, the VM #1 is operating on the server #1, the VM #2 is operating on the server #2, the VM #3 is operating on the server #3, and the VM #4 is operating on the server #4. FIG. 23 illustrates states of the server management table 15, the server group management table 16, the redundancy management table 11, the VM management table 13, and the physical path table 18 during the failure occurrence.

When a failure occurs in the link #6, the specifying unit 19 extracts the path #1 passing through the link #6 referring to the physical path table 18. Since the switches #1 and #3 are active, the specifying unit 19 determines that the path #1 is active referring to the redundancy management table 11. The specifying unit 19 extracts G#1-G#3 and G#2-G#3 as affected inter-server group communications referring to the physical path table 18. The specifying unit 19 confirms whether a standby path is present or not for the affected inter-server group communications referring to the physical path table 18. Then, since the path #2 is present in G#2-G#3, the specifying unit 19 determines that a standby path is present.

For G#1-G#3, the specifying unit 19 extracts communication between the servers #1-#4 as affected inter-server communication referring to the server management table 15. The specifying unit 19 extracts the VMs #1-#4 as affected inter-VM communication referring to the VM management table 13.

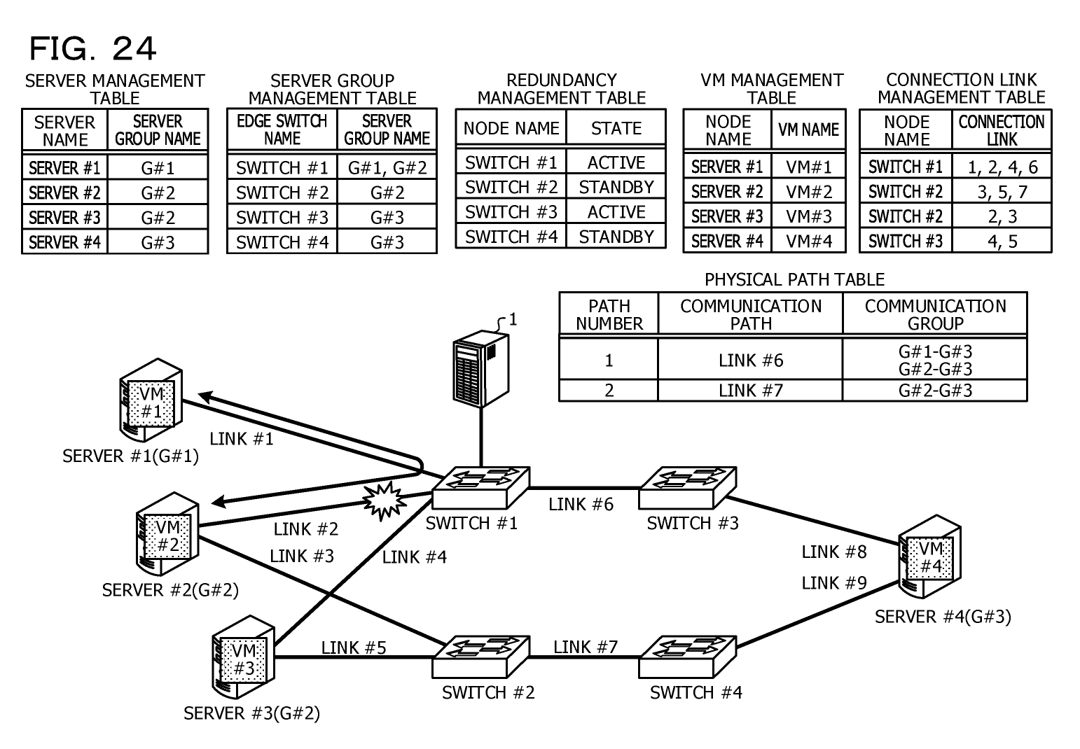

FIG. 24 is a diagram illustrating a state at the time when a failure occurs between the server 41 and the switch 42. FIG. 24 illustrates occurrence of a failure in the link #2. FIG. 24 illustrates states of the server management table 15, the server group management table 16, the redundancy management table 11, the VM management table 13, the connection link management table 12, and the physical path management table 18 during the failure occurrence.

The specifying unit 19 extracts the path #1 passing through the switch #1, to which the link #2 is connected, as an effected physical path referring to the connection link management table 12 and the physical path table 18. Since the switches #1 and #3 are active, the specifying unit 19 determines that the path #1 is active referring to the redundancy management table 11. The specifying unit 19 extracts G#2-G#3 as affected inter-server group communication referring to the physical path table 18. Note that, since the specifying unit 19 extracts only a path including the server group G#2 to which the server #2, to which the link #2 is connected, belongs, the specifying unit 19 does not extract G#1-G#3. For G#2-G#3, the specifying unit 19 determines that the path #2 is present as a standby path referring to the physical path table 18. Therefore, for the path #1, the specifying unit 19 determines that inter-server group communication affected by the failure of the link #2 is absent.

The specifying unit 19 creates a physical path of G#1-G#2 between server groups connected to the switch #1 referring to the server group management table 16. Since the switch #1 is active, the specifying unit 19 determines that G#1-G#2 is active referring to the redundancy management table 11. Since the switch 42 connected to the server groups G#1 and G#2 is absent other than the switch #1, the specifying unit 19 determines that a standby path is absent in G#1-G#2 referring to the server group management table 16. For G#1-G#2, the specifying unit 19 extracts the servers #1-#2 as affected inter-server communication referring to the server management table 15. Note that, for G#2, since only the server #2 connected to the link #2 is set as a target, the specifying unit 19 does not extract the servers #1-#3. The specifying unit 19 extracts the VMs #1-#2 as affected inter-VM communication referring to the VM management table 13.

The specifying unit 19 specifies, referring to the server management table 15, the servers #2-#3 as inter-server communication in the server group G#2 to which the server #2 connected to the link #2 belongs. Since the switch #1 is active, the specifying unit 19 determines that a physical path of the servers #2-#3 is active referring to the redundancy management table 11. The specifying unit 19 determines that a standby path is present in the servers #2-#3 referring to the connection link management table 12. Therefore, the specifying unit 19 determines that affected inter-server communication is absent in server groups including the servers 41 connected to the link 43 in which the failure occurs.

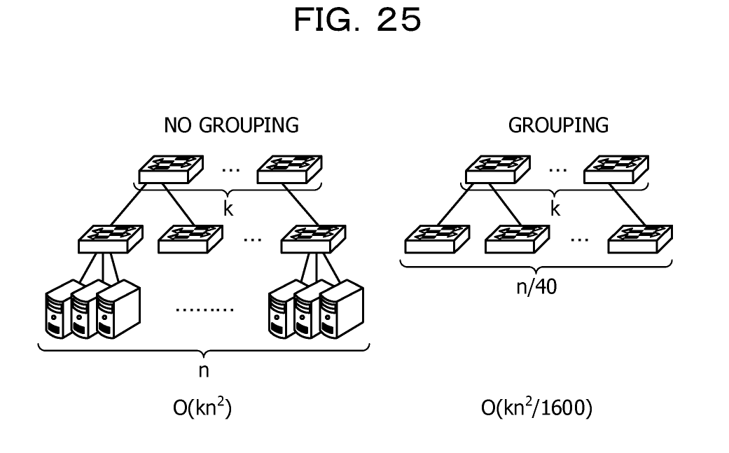

Effects obtained when the servers 41 are grouped are explained. FIG. 25 is a diagram for explaining the effects obtained when the servers 41 are grouped. FIG. 25 illustrates calculation amounts for creating path tables with and without grouping concerning a configuration in which n servers 41 are connected with k redundant paths by the switches 42 in two layers and forty servers 41 are connected to edge switches.

As illustrated in FIG. 25, when grouping is absent, a combination of servers is ₙC₂=n×(n−1)/2 and the number of redundant paths is k. Therefore, a calculation amount is O(kn²). O(x) indicates order of x, that is, indicates that an approximate value is x. On the other hand, in the case of grouping, the number of edge switches is n/40, a combination of the edge switches is _{n/40}C₂=n/40×(n/40−1)/2, and the number of redundant paths is k. Therefore, a calculation amount is O(kn²/1600). That is, the calculation amount is reduced to approximately 1/1600 by the grouping.

As explained above, in the first embodiment, the inter-group-communication specifying unit 21 specifies inter-server group communication affected by a failure referring to the physical path table 18 that associates the physical path and the two server groups that performs communication using the physical path. The inter-VM-communication specifying unit 22 specifies inter-server communication affected by the failure, referring to the server management table 15 that associates the servers 41 and the server groups based on the inter-server group communication specified by the inter-group-communication specifying unit 21. The inter-VM-communication specifying unit 22 specifies inter-VM communication affected by the failure referring to the VM management table 13. Therefore, the cloud management apparatus 1 may specify, in a short time, the inter-VM communication affected by the failure and may reduce a time taken for processing of specifying customers affected by the failure.

In the first embodiment, the inter-group-communication specifying unit 21 confirms whether a standby path is present or not for the specified inter-server group communication referring to the physical path table 18. When a standby path is present, the inter-group-communication specifying unit 21 determines that the inter-server group communication is not affected by the failure. Therefore, the cloud management apparatus 1 may accurately specify customers affected by the failure.

In the first embodiment, when a failure occurs in the link 43 between the server 41 and the edge switch, the inter-VM-communication specifying unit 22 specifies only inter-server communication including a connected server as inter-server communication affected by the failure. Therefore, the cloud management apparatus 1 may accurately specify the inter-server communication affected by the failure.

In the first embodiment, when a failure occurs in the link 43 between the server 41 and the edge switch, the inter-VM-communication specifying unit 22 specifies, as inter-server communication affected by the failure, communication performed by the connected server with the other servers 41 in a server group. Therefore, the cloud management apparatus 1 may accurately specify the inter-server communication affected by the failure.

In the first embodiment, the server-group creating unit 14 creates the server group management table 16 referring to the connection link management table 12. The physical-path creating unit 17 creates the physical path table 18 referring to the connection link management table 12 and the server group management table 16. Therefore, the cloud management apparatus 1 may reduce a time taken for the processing of creating the physical path table 18.

Note that, in the first embodiment, the cloud management apparatus 1 is explained. However, an influence range specifying program having the same function may be obtained by realizing, with software, the configuration included in the cloud management apparatus 1. Therefore, a computer that executes the influence range specifying program is explained.

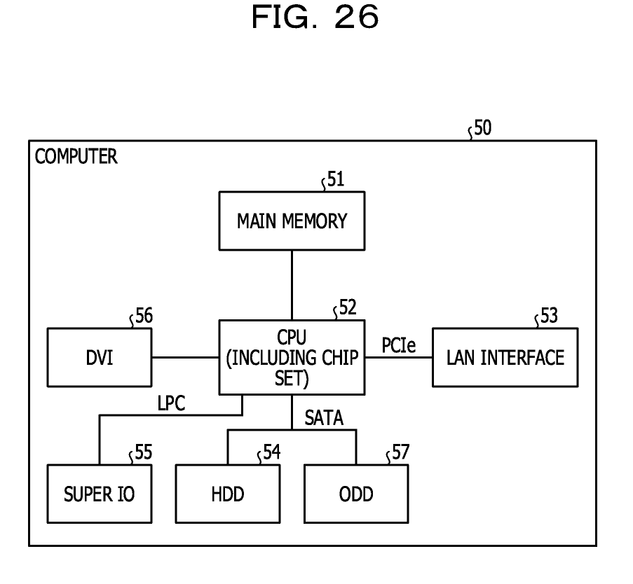

FIG. 26 is a diagram illustrating a hardware configuration of the computer that executes the influence range specifying program according to the first embodiment. As illustrated in FIG. 26, a computer 50 includes a main memory 51, a central processing unit (CPU) 52, a LAN interface 53, and a hard disk drive (HDD) 54. The computer 50 includes a super input output (IO) 55, a digital visual interface (DVI) 56, and an optical disk drive (ODD) 57.

The main memory 51 is a memory that stores a computer program, an execution halfway result of the computer program, and the like. The CPU 52 is a central processing device that reads out the computer program from the main memory 51 and executes the computer program. The CPU 52 includes a chip set including a memory controller.

The LAN interface 53 is an interface for connecting the computer 50 to other computers through a LAN. The HDD 54 is a disk device that stores computer programs and data. The super IO 55 is an interface for connecting input devices such as a mouse and a keyboard. The DVI 56 is an interface for connecting a liquid display device. The ODD 57 is a device that performs reading and writing of a DVD.

The LAN interface 53 is connected to the CPU 52 by a PCI express (PCIe). The HDD 54 and the ODD 57 are connected to the CPU 52 by a serial advanced technology attachment (SATA). The super IO 55 is connected to the CPU 52 by a low pin count (LPC).

The influence range specifying program executed in the computer 50 is stored in the DVD, read out from the DVD by the ODD 57, and installed in the computer 50. Alternatively, the influence range specifying program is stored in a database or the like of another computer system connected via the LAN interface 53, read out from the database, and installed in the computer 50. The installed data processing program is stored in the HDD 54, read out to the main memory 51, and executed by the CPU 52.

### Second Embodiment

Incidentally, in the above explanation in the first embodiment, an L3 relay apparatus that treats packets in the layer 3 or higher is not included in the information processing system. However, the L3 relay apparatus is sometimes included in the information processing system. Communication sometimes turns back at the L3 relay apparatus. Therefore, in the following explanation in a second embodiment, an information processing system includes the L3 relay apparatus.

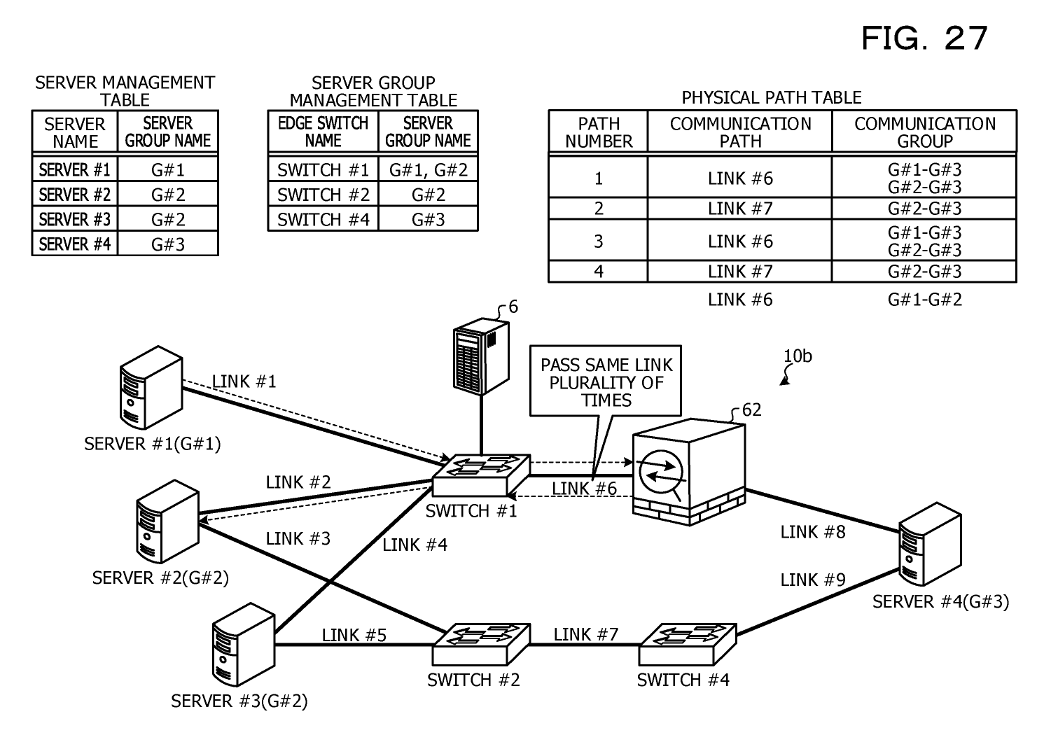

FIG. 27 is a diagram illustrating the information processing system including the L3 relay apparatus and a physical path table. Compared with FIG. 21, an information processing system 10b illustrated in FIG. 27 includes a firewall 62 instead of the switch #3. The firewall 62 is an apparatus that hinders an illegal access and the like from an external network. The firewall 62 treats packets in the layer 3 or higher. Note that, as the L3 relay apparatus, there are a router, a load balancer, and the like besides the apparatus.

Therefore, in the information processing system 10b, there is a physical path that reaches the server group G#2 from the server group G#1 turning back in the firewall 62. In the physical path, a packet passes the link #6 twice. Therefore, a cloud management apparatus 6 according to the second embodiment has to create a physical path table including a turning back path.

A cloud system may manage information on an information processing system in a data center but may be unable to manage information on a range exceeding a border edge of the data center. However, in a cloud system that operates in cooperation with an information processing system of a client, when a failure occurs, it is particularly important to specify presence or absence of influence on the information processing system of the client.

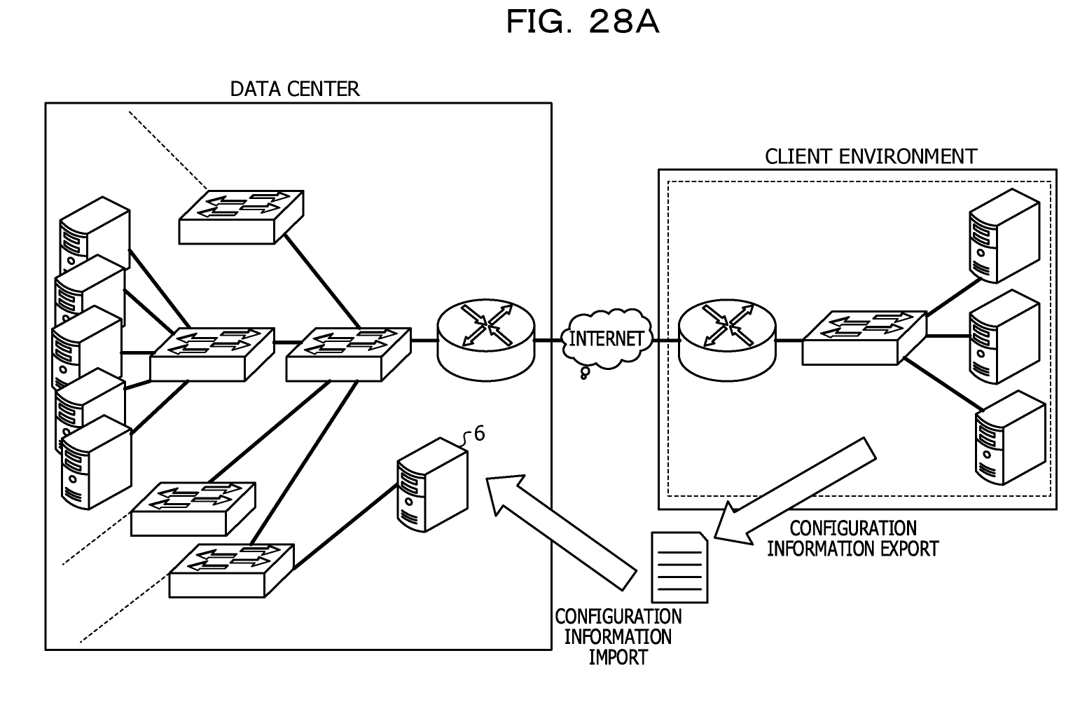

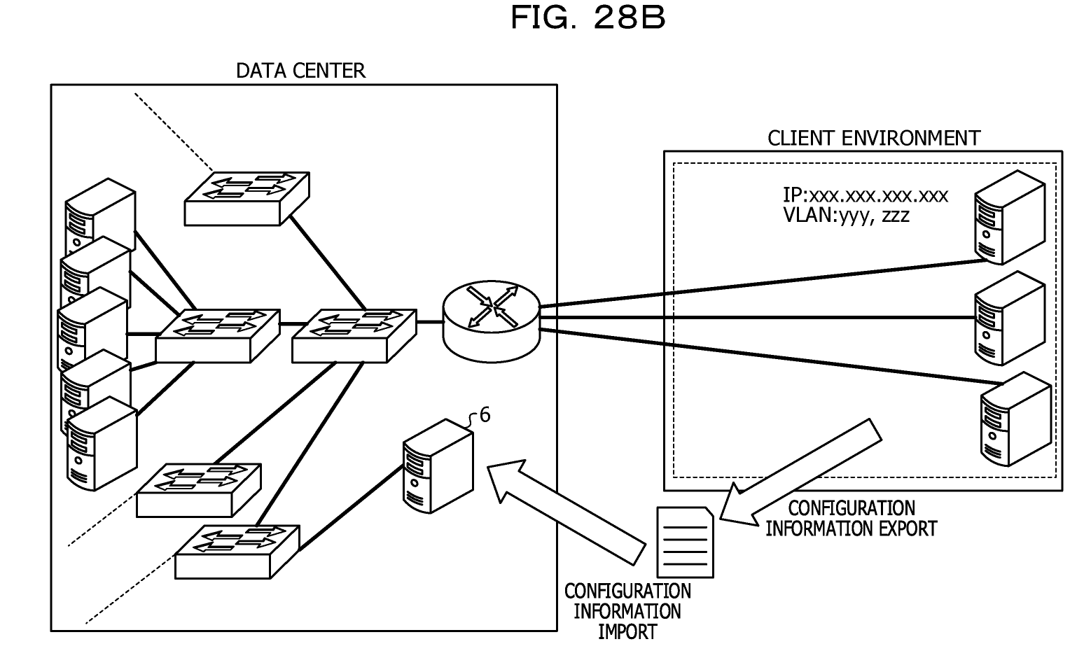

Therefore, the cloud management apparatus 6 collects configuration information of the information processing system of the client outside the data center. FIG. 28A is a diagram for explaining the collection of the configuration information of the information processing system outside the data center. The cloud management apparatus 6 may be unable to access configuration information of a client environment outside the data center. Therefore, basically, the cloud management apparatus 6 collects information according to a manual input.

Alternatively, as illustrated in FIG. 28A, when an agent program is introduced into a server in the client environment to export the configuration information, the cloud management apparatus 6 may import the configuration information. However, information on affected apparatuses only has to be known during an apparatus failure on the data center side. Therefore, the cloud management apparatus 6 does not have to collect complete connection information and only has to collect information from which it is seen in which VLANs servers are used.

In the case of a network illustrated in FIG. 28A, assuming that the cloud management apparatus 6 is connected as illustrated in FIG. 28B, the cloud management apparatus 6 may obtain desirable information. However, VLANs are not the same in the data center and the client environment. However, if a use of a server on the client environment side is known (if it is known which service of a data center side server is used), the VLANs may be linked. In FIG. 28B, an internet protocol (IP) address of the server in the client environment is “XXX.XXX.XXX.XXX”. The server uses a VLAN identified by “yyy” and “zzz”.

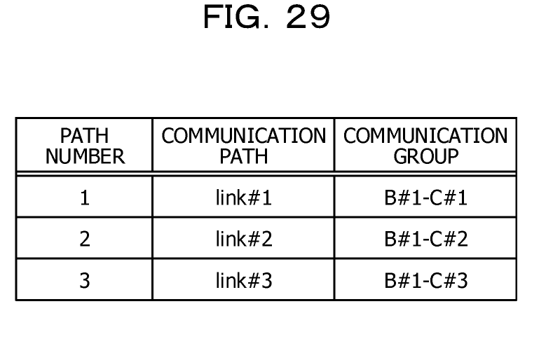

When a border edge on the data center side is represented by B#1 and server groups on the client side are represented by C#1, C#2, and C#3, as configuration information, an agent program on the server in the client environment may export a physical path table illustrated in FIG. 29. Alternatively, an administrator of the client environment may manually create the physical path table illustrated in FIG. 29.

The administrator of the client environment passes exported or created data to an administrator of the data center. The administrator of the data center may cause the cloud management apparatus 6 to import the data.

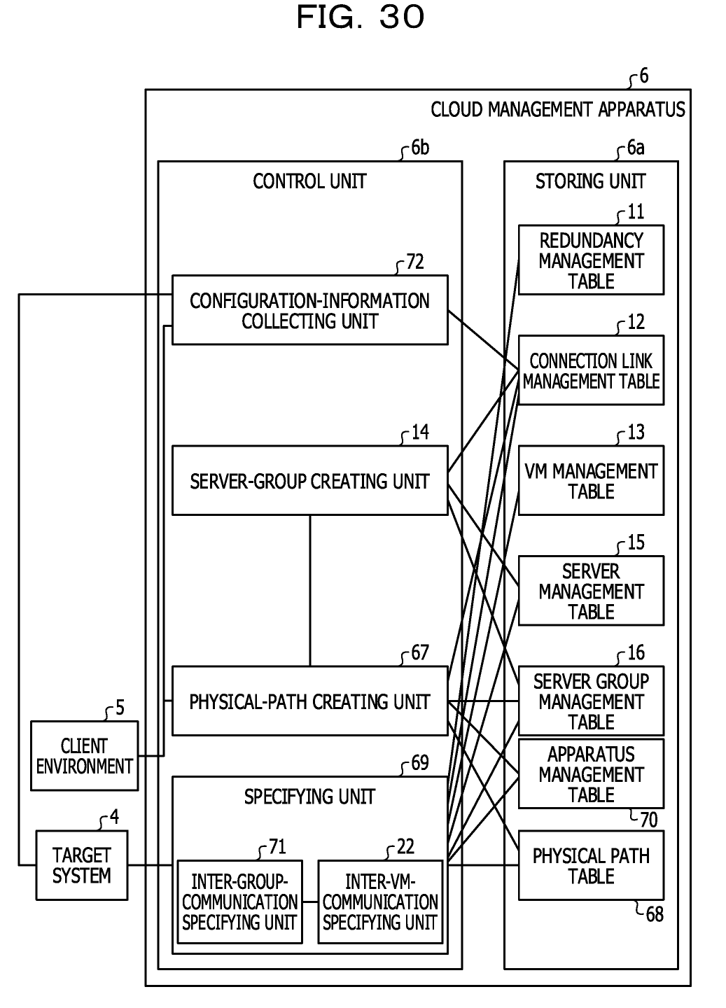

A functional configuration of the cloud management apparatus 6 is explained. FIG. 30 is a diagram illustrating the functional configuration of the cloud management apparatus 6. Note that, for convenience of explanation, functional units that play the same roles as the units illustrated in FIG. 2 are denoted by the same reference numerals and signs. Detailed explanation of the functional units is omitted. As illustrated in FIG. 30, compared with the cloud management apparatus 1 illustrated in FIG. 2, the cloud management apparatus 6 includes a storing unit 6a instead of the storing unit 1a and includes a control unit 6b instead of the control unit 1b.

Compared with the storing unit 1a, the storing unit 6a includes a physical path table 68 instead of the physical path table 18 and includes an apparatus management table 70 anew. Compared with the control unit 1b, the control unit 6b includes a physical-path creating unit 67 instead of the physical-path creating unit 17, includes a specifying unit 69 instead of the specifying unit 19, and includes a configuration-information collecting unit 72 anew. Compared with the specifying unit 19, the specifying unit 69 includes an inter-group-communication specifying unit 71 instead of the inter-group-communication specifying unit 21.

In the physical path table 68, when L3 relay apparatuses are not included in a physical path, the physical path and two server groups that perform communication using the physical path are registered. When L3 relay apparatuses are included in the physical path, in the physical path table 68, a physical path between one server group and the L3 relay apparatus, a physical path between the other server group and the L3 relay apparatus, and a physical path between the L3 relay apparatuses are registered.

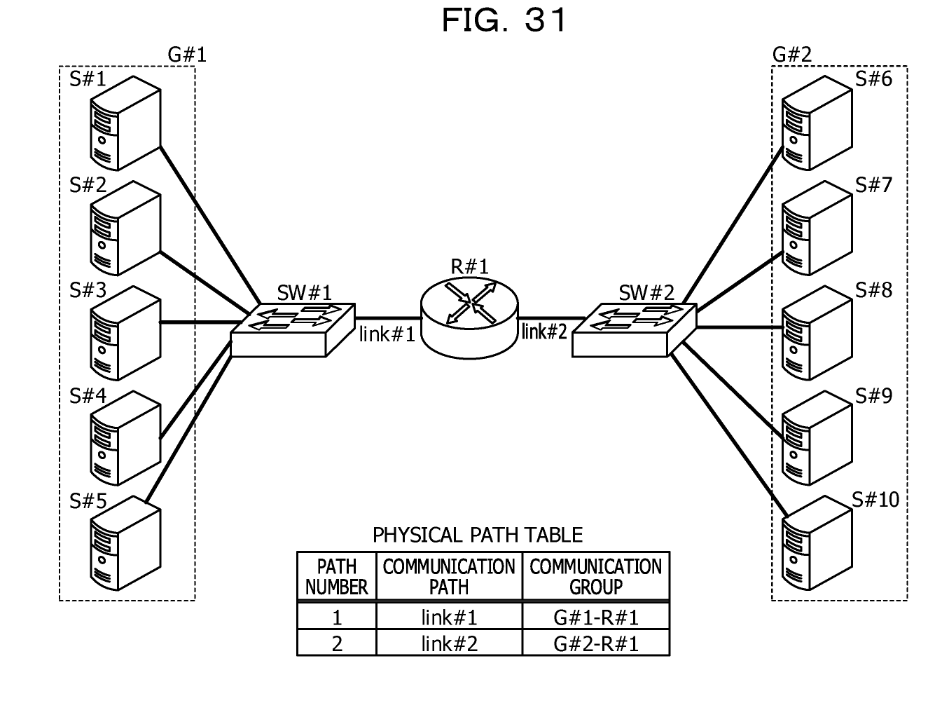

FIG. 31 is a diagram illustrating an example of the physical path table 68. In FIG. 31, when n is a positive integer, S#n represents the server 41, SW#n represents the switch 42, link#n represents the link 43, G#n represents a server group, and R#n represents a router.

As illustrated in FIG. 31, G#1 is connected to SW#1, SW#1 is connected to R#1 by link#1, R#1 is connected to SW#2 by link#2, and SW#2 is connected to G#2. Therefore, in the physical path table 68, as illustrated in FIG. 31, a communication group G#1-R#1 with link#1 set as a communication path and a communication group G#2-R#1 with link#2 set as a communication path are registered.

As a path between S#1 and S#6 across R#1, a path of G#1-R#1-G#2, that is, S#1-SW#1-R#1-SW#2-S#6 is calculated using information on the paths #1 and #2 of the physical path table 68. As a path between S#1 and S#2 not across R#1, a path of G#1-R#1-G#1, that is, S#1-SW#1-R#1-SW#1-S#2 is calculated using the information on the path #1 twice. Note that the path of S#1-SW#1-S#2 is calculated by the processing explained in the first embodiment.

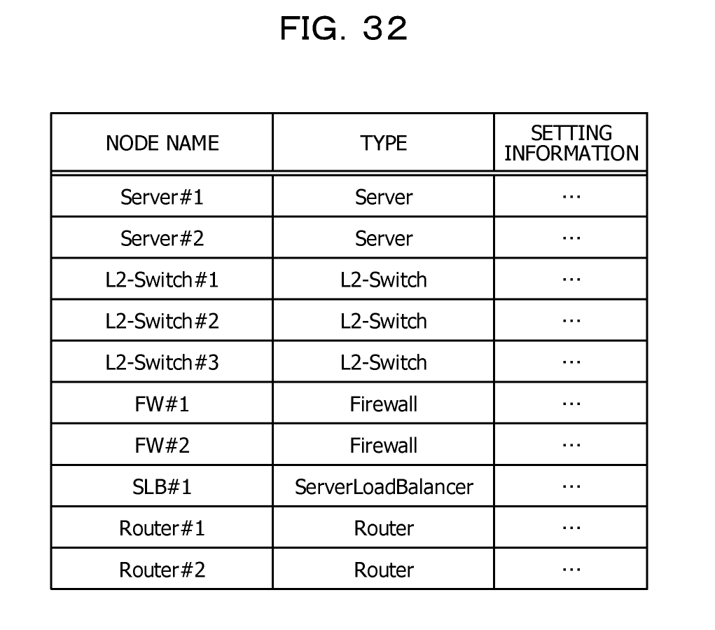

In the apparatus management table 70, types and setting information of apparatuses are registered. FIG. 32 is a diagram illustrating an example of the apparatus management table 70. As illustrated in FIG. 32, in the apparatus management table 70, information for associating, for each of the apparatuses, a node name, a type, and setting information is registered. The node name is a name for identifying the apparatus. The type indicates a type of the apparatus. The setting information is information set in the apparatus.

In the type in FIG. 32, “Server” indicates that the type is the server 41, “L2-Switch” indicates that the type is the switch 42, and “Firewall” indicates that the type is the firewall 62. “Server Load Balancer” indicates that the type is a load balancer and “Router” indicates that the type is a router.

The setting information is used when specifying an influence range. For example, in the case of the switch 42, information on which VLAN-ID is allocated to which link 43 is retained as the setting information. In the case of the router, what kinds of a routing table the router has is managed by the setting information. In the case of the firewall 62, what kinds of filtering is performed is managed by the setting information. A path in which communication is not originally performed according to these kinds of setting information is not used for specifying the influence range.

It is also possible to more finely specify an influence range on the client side by also defining, concerning configuration information of the client environment, which service in the data center the servers on the client side use and linking the definition with the setting information.

Note that, as a method of creating the apparatus management table 70, there is a method of creating the apparatus management table 70 using a simple network management protocol (SNMP). Apparatuses (in the case of the servers 41, OSs) adapted to the SNMP retain, as sysObjectIDs, values of management information bases (MIBs) that may uniquely specify vendors and types. Therefore, the cloud management apparatus 6 may retain, in advance, a table that associates sysObjectIDs and types and create the apparatus management table 70 by linking values of the sysObjectIDs collected from the apparatuses and the types.

The configuration-information collecting unit 72 reads network configuration information from a target system 4 and reads network configuration information from a client environment 5. The configuration-information collecting unit 72 creates the connection link management table 12 including network configuration information of the client environment 5.

Like the physical-path creating unit 17, the physical-path creating unit 67 specifies, referring to the connection link management table 12 and the server group management table 16, a set of the links 43 connecting two edge switches as a physical path and creates the physical path table 68. However, when L3 relay apparatuses are included between the two edge switches, the physical-path creating unit 67 creates the physical path table 68 divided into a path between one edge switch and the L3 relay apparatus, a path between the other edge switch and the L3 relay apparatus, and a path between the L3 relay apparatuses.

When the cloud management apparatus 6 imports the physical path table illustrated in FIG. 29, the physical-path creating unit 67 creates the physical path table 68 including information of the imported physical path table.

Like the inter-group-communication specifying unit 21, the inter-group-communication specifying unit 71 specifies inter-server group communication affected by an occurred failure. However, for a physical path in which one end or both ends of a communication group including the link 43 in which the failure occurs are L3 relay apparatuses, the inter-group-communication specifying unit 71 creates an inter-server group physical path crossing across the L3 relay apparatuses or turning back at the L3 relay apparatuses. The inter-group-communication specifying unit 71 specifies, based on information on the created physical path, inter-server group communication affected by the occurred failure.

The inter-group-communication specifying unit 71 excludes a physical path found as not being used according to the setting information of the apparatus management table 70 and specifies inter-server group communication affected by the occurred failure. For example, when a physical path in which the server #1 and the server #2 communicate across the firewall 62 is included as a physical path determined as an influence range, the inter-group-communication specifying unit 71 confirms setting information for the firewall 62 from the apparatus management table 70. When a definition “all packets addressed to the server #2 are discarded” is included in the setting information, the physical path is not used. Therefore, the inter-group-communication specifying unit 71 excludes the physical path from the influence range.

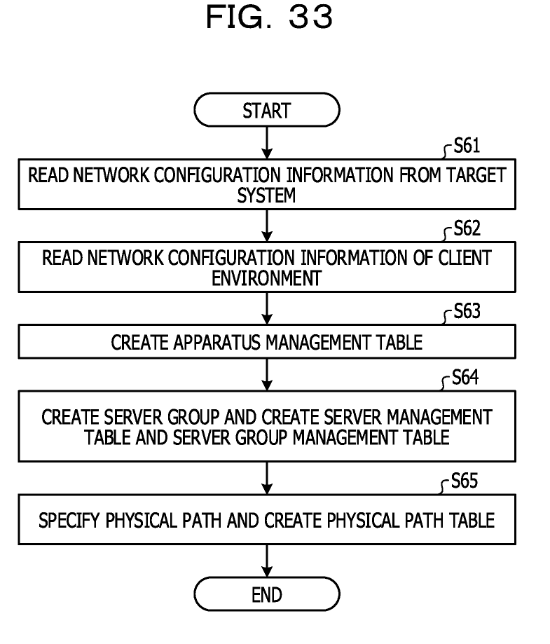

A flow of processing of the cloud management apparatus 6 is explained with reference to FIGS. 33 to 36. FIG. 33 is a flowchart illustrating a flow of processing until creation of the physical path table 68. As illustrated in FIG. 33, the cloud management apparatus 6 reads network configuration information from the target system 4 (step S61) and reads network configuration information of the client environment 5 (step S62). The cloud management apparatus 6 creates the apparatus management table 70 (step S63).

The cloud management apparatus 6 creates a server group and creates the server management table 15 and the server group management table 16 (step S64). The cloud management apparatus 6 specifies a physical path referring to the apparatus management table 70 in addition to the connection link management table 12 and the server group management table 16 and creates the physical path table 68 (step S65).

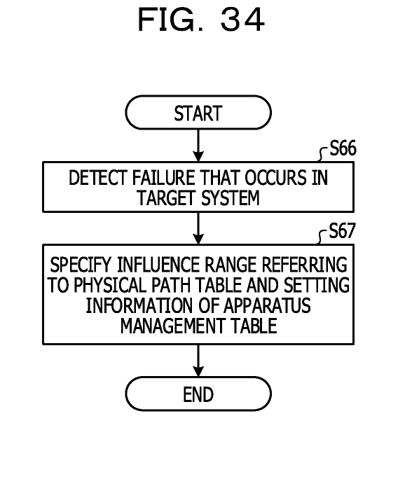

FIG. 34 is a flowchart illustrating a flow of processing of specifying an influence range during failure occurrence. As illustrated in FIG. 34, when a failure occurs, the cloud management apparatus 6 detects the failure that occurs in the target system 4 (step S66) and specifies an influence range referring to the physical path table 68 and the setting information of the apparatus management table 70 (step S67).

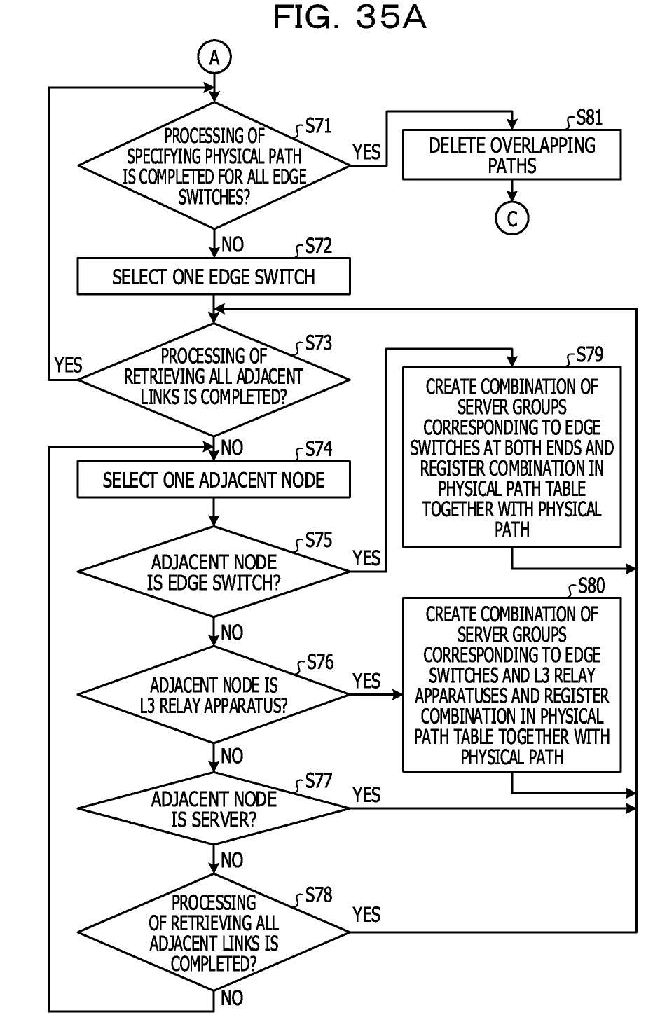

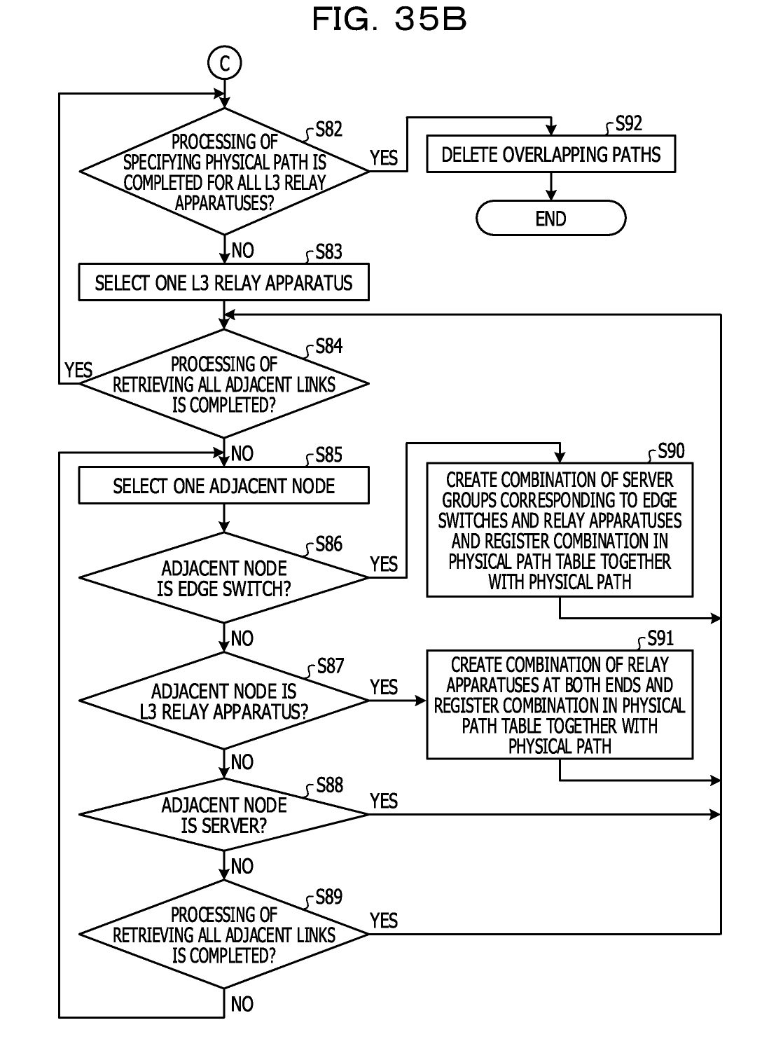

FIGS. 35A and 35B are flowcharts illustrating a flow of processing of creating the physical path table 68. As illustrated in FIG. 35A, the physical-path creating unit 67 determines whether processing of specifying a physical path is completed for all the edge switches (step S71). As a result, when an edge switch on which the processing of specifying a physical path is not performed is present, the physical-path creating unit 67 selects one edge switch (step S72). The physical-path creating unit 67 determines whether processing of retrieving all adjacent links is completed for the selected edge switch (step S73). When adjacent links not retrieved are present, the physical-path creating unit 67 selects one adjacent node (step S74).

The physical-path creating unit 67 determines whether the selected adjacent node is an edge switch (step S75). When the selected adjacent node is not an edge switch, the physical-path creating unit 67 determines whether the adjacent node is an L3 relay apparatus (step S76). When the adjacent node is not an L3 relay apparatus, the physical-path creating unit 67 determines whether the adjacent node is the server 41 (step S77). As a result, when the adjacent node is not the server 41, the physical-path creating unit 67 determines whether the processing of retrieving all adjacent links is completed for the adjacent node (step S78). When adjacent links not retrieved are present, the physical-path creating unit 67 returns to step S74.

On the other hand, when the processing of retrieving all adjacent links is completed for the adjacent node or when the adjacent node is the server 41, the physical-path creating unit 67 returns to step S73. When determining in step S76 that the adjacent node is an L3 relay apparatus, the physical-path creating unit 67 creates a combination of a server group corresponding to the edge switch and the L3 relay apparatus and registers the combination in the physical path table 68 together with the physical path (step S80). The physical-path creating unit 67 returns to step S73.

When determining in step S75 that the adjacent node is an edge switch, the physical-path creating unit 67 creates a combination of server groups corresponding to edge switches at both ends of the retrieved physical path and registers the combination in the physical path table 68 together with the physical path (step S79). The physical-path creating unit 67 returns to step S73.

When determining in step S73 that the processing of retrieving all adjacent links is completed, the physical-path creating unit 67 returns to step S71. When determining in step S71 that the processing of specifying a physical path is completed for all the edge switches, the physical-path creating unit 67 deletes overlapping paths from the physical path table 68 (step S81).

As illustrated in FIG. 35B, the physical-path creating unit 67 determines whether the processing of specifying a physical path is completed for all the L3 relay apparatuses (step S82). As a result, when L3 relay apparatuses on which the processing of specifying a physical path is not performed are present, the physical-path creating unit 67 selects one L3 relay apparatus (step S83). The physical-path creating unit 67 determines whether the processing of retrieving all adjacent links is completed for the selected L3 relay apparatus (step S84). When adjacent links not retrieved are present, the physical-path creating unit 67 selects one adjacent node (step S85).

The physical-path creating unit 67 determines whether the selected adjacent node is an edge switch (step S86). When the selected adjacent node is not an edge switch, the physical-path creating unit 67 determines whether the adjacent node is an L3 relay apparatus (step S87). When the adjacent node is not an L3 relay apparatus, the physical-path creating unit 67 determines whether the adjacent node is the server 41 (step S88). As a result, when the adjacent node is not the server 41, the physical-path creating unit 67 determines whether the processing of retrieving all adjacent links is completed for the adjacent node (step S89). When adjacent links not retrieved are present, the physical-path creating unit 67 returns to step S85.

On the other hand, when the processing of retrieving all adjacent links is completed for the adjacent node or when the adjacent node is the server 41, the physical-path creating unit 67 returns to step S84. When determining in step S87 that the adjacent node is an L3 relay apparatus, the physical-path creating unit 67 creates a combination of relay apparatuses at both ends and registers the combination in the physical path table 68 together with the physical path (step S91). The physical-path creating unit 67 returns to step S84.

When determining in step S86 that the adjacent node is an edge switch, the physical-path creating unit 67 creates a combination of a server group corresponding to the edge switch and the relay apparatus and registers the combination in the physical path table 68 together with the physical path (step S90). The physical-path creating unit 67 returns to step S84.

When determining in step S84 that the processing of retrieving all adjacent links is completed, the physical-path creating unit 67 returns to step S82. When determining in step S82 that the processing of specifying a physical path is completed for all the L3 relay apparatuses, the physical-path creating unit 67 deletes overlapping paths from the physical path table 68 (step S92) and ends the processing of creating the physical path table 68.

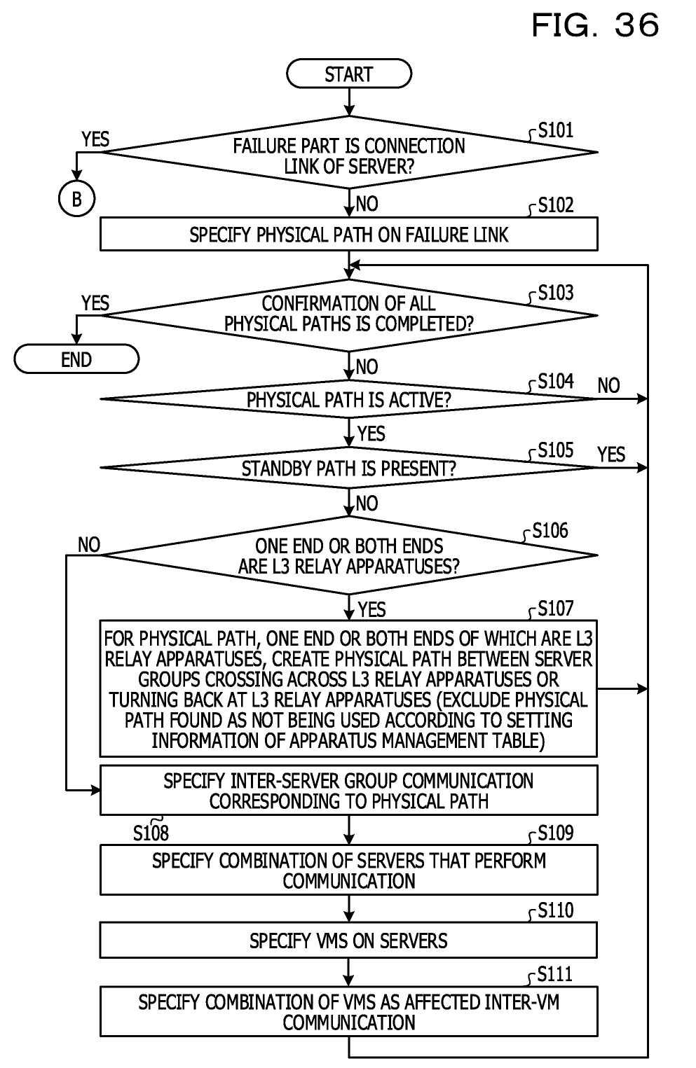

FIG. 36 is a third flowchart illustrating the flow of the processing of specifying an influence range. As illustrated in FIG. 36, the specifying unit 69 determines whether a failure part is a connection link of the server 41 (step S101). When the failure part is not the connection link of the server 41, the specifying unit 69 specifies a physical path on a failure link (step S102). The specifying unit 69 determines whether confirmation of all the physical paths is completed (step S103). When the confirmation of all the physical paths is completed, the specifying unit 69 ends the processing.

On the other hand, when physical paths not confirmed are present, the specifying unit 69 determines whether one of the specified physical paths is active (step S104). When the physical path is not active, the specifying unit 69 returns to step S103. On the other hand, when the physical path is active, the specifying unit 69 determines whether a standby path is present (step S105). When a standby path is present, the specifying unit 69 returns to step S103.

On the other hand, when a standby path is absent, the specifying unit 69 determines whether one end or both ends of the physical path are L3 relay apparatuses (step S106). When the one end or both the ends are L3 relay apparatuses, the specifying unit 69 creates, for the physical path, the one end or both the ends of which are the L3 relay apparatuses, a physical path between server groups crossing across the L3 relay apparatuses or turning back at the L3 relay apparatuses (step S107). However, the specifying unit 69 excludes the physical path found as not being used according to the setting information of the management table 70.

The specifying unit 69 specifies inter-server group communication corresponding to the physical path (step S108) and determines, based on the specified inter-server group communication, a combination of the servers 41 that perform communication (step S109). The specifying unit 69 specifies the VMs 44 on the specified servers (step S110) and specifies a combination of the specified VMs 44 as affected inter-VM communication (step S111). The specifying unit 69 returns to step S103.

When determining in step S101 that the failure part is a connection link of the server 41, the specifying unit 69 shifts to step S40 in FIG. 15B. Like the specifying unit 19, the specifying unit 69 performs the processing in steps S40 to S53.

In this way, the physical-path creating unit 67 creates, referring to the apparatus management table 70, the physical path table 68 including a communication group, one end or both ends of which are L3 relay apparatuses. In the physical path table 68, when one end or both ends of a communication group corresponding to the physical path including the link 43 in which a failure occurs are L3 relay apparatuses, the specifying unit 69 specifies inter-server group communication turning back at the L3 relay apparatuses or crossing across the L3 relay apparatuses. Therefore, the cloud management apparatus 6 may accurately specify an influence range when a failure occurs in the information processing system 10b including the L3 relay apparatuses.

The cloud management apparatus 6 may specify presence or absence of influence on the client environment 5 during failure occurrence by reading network information of the client environment 5 and creating the physical path table 68. The cloud management apparatus 6 may specify an influence range excluding a physical path not in use by specifying an influence range referring to the setting information of the apparatus management table 70.

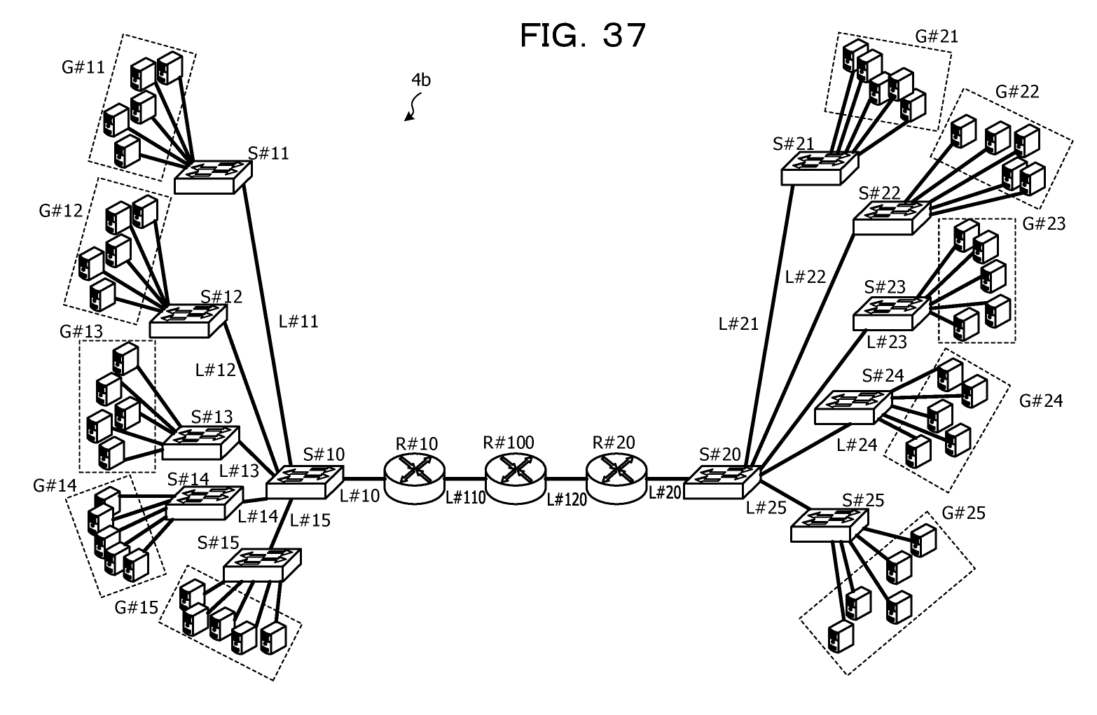

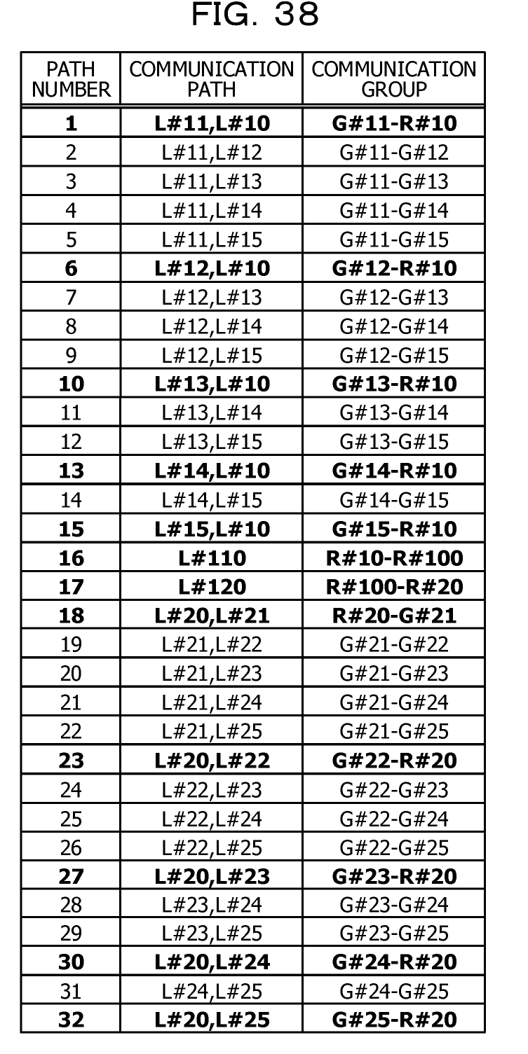

An example of specifying an influence range is explained with reference to FIGS. 37 and 38. FIG. 37 is a diagram illustrating the configuration of a target system 4b, an influence range of which is specified. In FIG. 37, when n is a positive integer, G#n represents a server group, S#n represents the switch 42, L#n represents the link 43, and R#n represents a router.

As illustrated in FIG. 37, G#11 is connected to S#11, G#12 is connected to S#12, G#13 is connected to S#13, G#14 is connected to S#14, and G#15 is connected to S#15. S#11 is connected to S#10 by L#11, S#12 is connected to S#10 by L#12, S#13 is connected to S#10 by L#13, S#14 is connected to S#10 by L#14, and S#15 is connected to S#10 by L#15. The SW#10 is connected to R#10 by L#10. R#10 is connected to R#100 by L#110.

G#21 is connected to S#21, G#22 is connected to S#22, G#23 is connected to S#23, G#24 is connected to S#24, and G#25 is connected to S#25. S#21 is connected to S#20 by L#21, S#22 is connected to S#20 by L#22, S#23 is connected to S#20 by L#23, S#24 is connected to S#20 by L#24, and S#25 is connected to S#20 by L#25. SW#20 is connected to R#20 by L#20. R#20 is connected to R#100 by L#120.

FIG. 38 is a diagram illustrating the physical path table 68 created for the target system 4b illustrated in FIG. 37. For example, “G#11-R#10” with L#11 and L#10 set as physical paths is registered in a path #1. “G#12-R#10” with L#12 and L#10 set as physical paths is registered in a path #6. “G#13-R#10” with L#13 and L#10 set as physical paths is registered in a path #10. “G#15-R#10” with L#15 and L#10 set as physical paths is registered in a path #15. “R#10-R#100” with L#110 set as a physical path is registered in a path #16.

When a failure is detected in L#10 in FIG. 37, the specifying unit 69 specifies, as affected physical paths, the paths #1, #6, #10, #13, and #15 including L#10. For the physical paths, since one ends or both ends are L3 relay apparatuses, the specifying unit 69 specifies, using the physical path table 68 of FIG. 38, all inter-server group communications crossing across the L3 relay apparatuses or turning back at the L3 relay apparatuses.

Specifically, for the path #1, physical paths including R#10 are the paths #6, #10, #13, #15, and #16 excluding the path #1. Therefore, as inter-server group communications turning back at R#10, G#11-G#12 (the paths #1 and #6), G#11-G#13 (the paths #1 and #10), G#11-G#14 (the paths #1 and #13), and G#11-G#15 (the paths #1 and #15) are specified.

G#11-R#100 (the paths #1 and #16) is specified as a communication group crossing across R#10. Since R#100 is an L3 relay apparatus, G#11-R#20 is specified using a path #17, which is a physical path including R#100 and excluding the path #16. Since R#20 is an L3 relay apparatus, paths #18, #23, #27, #30, and #32 are specified as physical paths including R#20 and excluding the path #17.

G#11-G#21 (the paths #1, #16, #17, and #18) is specified using the path #18. G#11-G#22 (the paths #1, #16, #17, and #23) is specified using the path #23. G#11-G#23 (the paths #1, #16, #17, and t #27) is specified using the path #27. G#11-G#24 (the paths #1, #16, #17, and #30) is specified using the path #30. G#11-G#25 (the paths #1, #16, #17, and #32) is specified using the path #32.

Similarly, for the path #6, as inter-server group communications turning back at R#10, G#12-G#11, G#12-G#13, G#12-G#14, and G#12-G#15 are specified. As inter-server group communications crossing across R#10, R#100, and R#20, G#12-G#21, G#12-G#22, G#12-G#23, G#12-G#24, and G#12-G#25 are specified.

Similarly, for the path #10, as inter-server group communications turning back at R#10, G#13-G#11, G#13-G#12, G#13-G#14, and G#13-G#15 are specified. As inter-server group communications crossing across R#10, R#100, and R#20, G#13-G#21, G#13-G#22, G#13-G#23, G#13-G#24, and G#13-G#25 are specified.

Similarly, for the path #13, as inter-server group communications turning back at R#10, G#14-G#11, G#14-G#12, G#14-G#13, and G#14-G#15 are specified. As inter-server group communications crossing across R#10, R#100, and R#20, G#14-G#21, G#14-G#22, G#14-G#23, G#14-G#24, and G#14-G#25 are specified.

Similarly, for the path #15, as inter-server group communications turning back at R#10, G#15-G#11, G#15-G#12, G#15-G#13, and G#15-G#14 are specified. As inter-server group communications crossing across R#10, R#100, and R#20, G#15-G#21, G#15-G#22, G#15-G#23, G#15-G#24, and G#15-G#25 are specified.

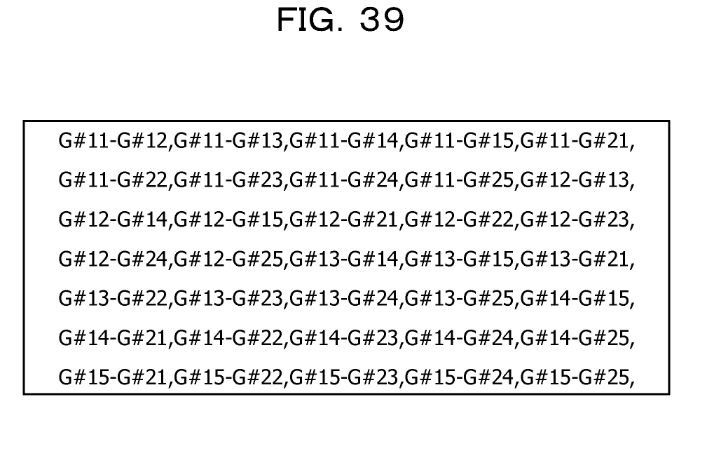

The specifying unit 69 removes overlaps from the specified inter-server group communications and specifies inter-server group communications illustrated in FIG. 39 as inter-server group communications affected by a failure.

Note that the specifying unit 69 confirms the setting information of the apparatus management table 70 at timing when inter-server group communication turning back at an L3 relay apparatus or inter-server group communication crossing across the L3 relay apparatus is specified. When communication is not performed, the specifying unit 69 excludes the inter-server group communication.

For example, at timing when inter-server group communication G#11-G#12 of the path #1 is specified, the specifying unit 69 understands that the inter-server group communication passes through R#10, S#10, S#11, and S#12. Therefore, the specifying unit 69 checks setting information of R#10, S#10, S#11, and S#12 from the apparatus management table 70.

Specifically, the specifying unit 69 analyzes setting information of ports of the apparatuses and routing information of R#10. When determining that G#11 and G#12 belong to the same network (on the same VLAN) and do not perform communication through R#10, the specifying unit 69 excludes G#11-G#12 from an influence range. Conversely, when determining that G#11 and G#12 belong to different networks (on different VLANs) and communication is turned back at R#10, the specifying unit 69 does not exclude G#11-G#12.

As explained above, in the second embodiment, when L3 relay apparatuses is included in the target system 4, the physical-path creating unit 67 creates the physical path table 68 including a communication group, one end or both ends of which are the L3 relay apparatuses. The inter-group-communication specifying unit 71 specifies, for a physical path in which one end or both ends of a communication group including the link 43 in which a failure occurs are L3 relay apparatuses, inter-server group communications crossing across the L3 relay apparatuses or turning back at the L3 relay apparatuses. Therefore, when a failure occurs in the target system 4 including the L3 relay apparatuses, the cloud management apparatus 6 may accurately specify customers affected by the failure.

In the second embodiment, the configuration-information collecting unit 72 collects network configuration information of the client environment 5. The physical-path creating unit 67 creates the physical path table 68 including the client environment 5. The inter-group-communication specifying unit 71 specifies, using the physical path table 68, inter-server group communication affected by a failure including the client environment 5. Therefore, when a failure occurs, the cloud management apparatus 6 may specify presence or absence of influence on the client environment 5.

In the second embodiment, when specifying inter-server group communication affected by a failure, the inter-group-communication specifying unit 71 excludes, using the setting information of the apparatus management table 70, inter-server group communication in which communication is not performed. Therefore, the cloud management apparatus 6 may accurately specify customers affected by the failure.

Note that, in the above explanation in the second embodiment, server groups are created and inter-server group communication affected by a failure are specified. However, the present disclosure is not limited to this and may be applied when inter-server communication affected by the failure is specified. For example, the inter-server group communication may be changed to the inter-server communication by providing a server group for each server. Alternatively, the inter-server communication may be specified without performing the creation of a server group by the server-group creating unit 14.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system management apparatus for managing a network system including a plurality of relay apparatuses including a layer 3 (L3) relay apparatus and a plurality of information processing apparatuses, the system management apparatus comprising:
a memory; and
a processor coupled to the memory and the processor configured to:
perform specifying of a first communication path including the L3 relay apparatus between a first pair of information processing apparatuses included in the network system and a second communication path not including any L3 relay apparatus between a second pair of information processing apparatuses included in the network system;
store, for each of the first communication path and the second communication path, management information in the memory, the management information including information of the first communication path and the second communication path in association with information of the first pair of information processing apparatuses and the second pair of information processing apparatuses respectively; and
when a failure occurs in the network system, perform a detection of communication between a third pair of information processing apparatuses affected by the failure in accordance with the management information, and output information relative to the communication between the third pair of information processing apparatuses.

2. The system management apparatus according to claim 1, wherein the detection includes detecting a third communication path in which the failure occurs, and specifying a communication path between the third pair of information processing apparatuses by referring to the management information, the communication path including the third communication path.

3. The system management apparatus according to claim 1, wherein
the network system includes a first information processing apparatus included in a data center and a second information processing apparatus included in an information processing system of a client that uses the data center, and
the specifying includes acquiring information of the first information processing apparatus and the second information processing apparatus and specifying a communication path between the first information processing apparatus and the second information processing apparatus.

4. The system management apparatus according to claim 1, wherein the specifying includes specifying a third communication path between a fourth pair information processing apparatuses included in the network system, the third communication path turning back at the L3 relay apparatus.

5. The system management apparatus according to claim 1, wherein the specifying includes specifying the first communication path on the basis of setting information of the L3 relay apparatus.

6. The system management apparatus according to claim 1, wherein
the specifying includes specifying a third communication path between a forth pair of information processing apparatuses included in the network system, the third communication path passing through another L3 relay apparatus and
the detection includes detecting the communication between the third pair of information processing apparatuses by using information of a communication path between the L3 relay apparatuses and the other L3 relay apparatus, the information being included in the management information.

7. A system management method executed by a computer, the method comprising:
specifying a first communication path including a layer 3 relay apparatus between a first pair of information processing apparatuses included in a network system and a second communication path not including any layer 3 relay apparatus between a second pair of information processing apparatuses included in the network system;
storing, for each of the first communication path and the second communication path, management information in a storage, the management information including information of the first communication path and the second communication path in association with information of the first pair of information processing apparatuses and the second pair of information processing apparatuses respectively; and
when a failure occurs in the network system, detecting communication between a third pair of information processing apparatuses affected by the failure in accordance with the management information, and outputting information relative to the communication between the third pair of information processing apparatuses.

8. The system management method according to claim 7, wherein the detecting includes detecting a third communication path in which the failure occurs, and specifying a communication path between the third pair of information processing apparatuses by referring to the management information, the communication path including the third communication path.

9. The system management method according to claim 7, wherein
the network system includes a first information processing apparatus included in a data center and a second information processing apparatus included in an information processing system of a client that uses the data center, and
the specifying includes acquiring information of the first information processing apparatus and the second information processing apparatus and specifying a communication path between the first information processing apparatus and the second information processing apparatus.

10. The system management method according to claim 7, wherein the specifying includes specifying a third communication path between information processing apparatuses included in the network system, the third communication path turning back at the layer 3 relay apparatus.

11. The system management method according to claim 7, wherein the specifying includes specifying the first communication path on the basis of setting information of the layer 3 relay apparatus.

12. The system management method according to claim 7, wherein
the specifying includes specifying a third communication path between a fourth pair of information processing apparatuses included in the network system, the third communication path passing through another layer 3 relay apparatus, and
the detecting includes detecting the communication between the third pair of information processing apparatuses by using information of a communication path between the layer 3 relay apparatuses and the other layer 3 relay apparatus, the information being included in the management information.

13. A non-transitory computer-readable medium storing a system management program that causes a computer to execute a process comprising:
specifying a first communication path including a layer 3 relay apparatus between a first pair of information processing apparatuses included in a network system and a second communication path not including any layer 3 relay apparatus between a second pair of information processing apparatuses included in the network system;
storing, for each of the first communication path and the second communication path, management information in a storage, the management information including information of the first communication path and the second communication path in association with information of the first pair of information processing apparatuses and the second pair of information processing apparatuses respectively; and
when a failure occurs in the network system, detecting communication between a third pair of information processing apparatuses affected by the failure in accordance with the management information, and outputting information relative to the communication between the third pair of information processing apparatuses.
